(19) United States
(12) Patent Application Publication
(10) Pub. No.: US 2016/0074861 A1
(43) Pub. Date: Mar. 17, 2016

(54) Portable Analytic Device and Methods of Use Thereof

(71) Applicant: The Penn State Research Foundation, University Park, PA (US)

(72) Inventors: Scott Thomas Phillips, State College, PA (US); Gregory Gerald Lewis, State College, PA (US); Dustin Wayne Ritter, State College, PA (US); Adam Brooks, Dexter, NY (US)

(21) Appl. No.: 14/949,166

(22) Filed: Nov. 23, 2015

Related U.S. Application Data
(63) Continuation-in-part of application No. 14/311,036, filed on Jun. 20, 2014.
(60) Provisional application No. 62/082,786, filed on Nov. 21, 2014.
(60) Provisional application No. 61/900,555, filed on Nov. 6, 2013.
(60) Provisional application No. 61/838,097, filed on Jun. 21, 2013.

(51) Int. Cl. B01L 3/00; C07F 5/04; C08G 65/00; B01L 99/00

(52) U.S. Cl. CPC B01L 3/5023; B01L 99/00; C07F 5/04; C08G 65/002; B01L 2300/165; B01L 2300/161; B01L 2300/0627; B01L 2300/0654; B01L 2300/0838

(57) ABSTRACT

A portable analytic apparatus is provided that is capillary-driven and capable of detecting analytes within a sample and providing an unambiguous positive/negative response. Embodiments provide for a hydrophobic detection reagent within a hydrophilic porous media, where a hydrophobic detection reagent changes to hydrophilic products in a presence/absence of a target analyte. This change from hydrophobic to hydrophilic provides a means to achieve a desired result of generating an unambiguous qualitative and/or quantitative positive/negative readout by forcing samples to wick at differential rates through hydrophilic regions towards a detection region. Suitable hydrophobic detection reagents are also provided.

### CROSS REFERENCE TO RELATED APPLICATIONS

This application claims priority to U.S. Provisional Application No. 62/082,786, filed on Nov. 21, 2014, and is a Continuation in Part of U.S. application Ser. No. 14/311,036 filed Jun. 20, 2014, claiming priority to U.S. Provisional Application No. 61/900,555, filed on Nov. 6, 2013, and U.S. Provisional Application No. 61/838,097, filed on Jun. 21, 2013, all of which are incorporated herein by reference in their entirety.

### STATEMENT OF GOVERNMENT INTEREST

This invention was made with government support under Grant No. CHE1150969, awarded by the National Science Foundation and under Grant No. GM105686, awarded by the National Institutes of Health. The Government has certain rights in the invention.

### FIELD

This present disclosure relates generally to portable analytic devices, and particularly to portable assay devices to provide qualitative and quantitative analytics.

### BACKGROUND

Portable devices configured to provide analytic testing can offer an effective means for diagnostic investigation outside laboratory environments. A particularly useful analytic device may be a point-of-care (“POC”) testing device. These devices can provide diagnostic investigation results by conducting the testing at, or near, the area of operation, such as at a contamination site, near a patient outside of the laboratory/hospital, or at a quality control point in a process flow. A utility provided by POCs may be the ability to use them in resource-limited environments. POC diagnostic devices can be used to address a variety of needs, such as water quality, detection of infectious diseases, and the like.

A particular POC diagnostic device is a POC assay. Typically, in resource-limited environments, POC assays should: 1) be low cost; 2) provide quick yet accurate, precise results; 3) contain thermally stable reagents; and, 4) minimize required equipment and training. Lateral flow test strips (e.g., lateral flow assays or dipsticks) may be used as a POC assay, which can be simple and lost cost. Examples of such devices may be pH paper and lateral flow immunoassays. Utilizing reagents that are stored in a dry form, these assays can be thermally stable, and may require minimal user manipulation (e.g., usually only the addition of a sample).

Nonetheless, prior art assays are configured to sacrifice some analytical capabilities, such as sensitivity and the ability to perform multiplex assays, in order to provide simple, rapid responses. Furthermore, prior art assays consist of lateral flow immunoassays utilizing a two-line readout, which can have the proclivity to provide ambiguous readouts that even the most sophisticated user finds difficult to properly interpret.

Thus, there is a need for a technical solution to provide an analytic device that is portable, cost effective, and generates quick yet accurate and precise results without compromising the analytical and functional capabilities described above.

### SUMMARY

The present disclosure describes an analytic apparatus that can be a capillary-driven device capable of detecting analytes within a sample and providing an unambiguous positive/negative response. Some embodiments can include a hydrophobic detection reagent within a hydrophilic porous media, wherein a hydrophobic detection reagent can be converted to hydrophilic products in the presence/absence of a target analyte. This change in properties of the detection reagent from hydrophobic to hydrophilic can be used to generate unambiguous qualitative and/or quantitative positive/negative readouts. For example, an analytic apparatus can be structured such that samples added can be forced to move differential rates through hydrophilic regions towards a detection region. The differentiated movement can be due to differentiate wicking rates via capillary action.

In at least one embodiment, an analytic apparatus can include a casing having a sample addition port in fluid communication with a detection region via a flow layer, an assay channel, and a control channel. A flow layer can include a hydrophilic region including hydrophobic barriers. The hydrophilic region may include hydrophilic porous media configured to enable directional flow of fluids, which may be dictated by at least one of the hydrophobic barriers. Within a hydrophilic region may be a hydrophobic detection reagent configured to convert from hydrophobic to hydrophilic and/or modify wetting properties of the hydrophilic region upon contact with a chemical promoter. Responsive agents may be included in an assay channel and/or a control channel. A responsive agent may produce a chemical promoter in response to presence of and/or absence of a target analyte. A sample fluid (which may or may not contain a target analyte) introduced into a sample addition port may move at differential rates through one of the flow channels due to differential amounts and/or rates of a chemical promoter produced within an assay channel and/or a control channel.

Some embodiments can include an apparatus configured to determine a presence and/or a concentration of a target analyte within a sample when a sample is introduced into a sample addition port. This may be achieved by configuring an apparatus to have an assay channel and a control channel directed towards a detection region so that a sample, after being introduced into a sample addition port, can be split into a first sample-portion and a second sample-portion. The sample-portions can be differentially driven towards a detection region. An apparatus can be further configured to generate a detection signal when a sample-portion contacts a detection region.

Other embodiments of the analytic apparatus can include a casing that may comprise a sample addition port in fluid communication with a detection region via a flow layer, an assay channel, and a control channel. At least one flow layer may comprise a hydrophilic region and a hydrophobic barrier. At least one hydrophilic region may comprise a hydrophilic porous media that can be configured to enable directional flow of fluids via capillary action. Each hydrophilic region and the directional flow there-through can be dictated by a hydrophobic barrier.

At least one hydrophilic region may be configured to filter impurities of the fluids via selective pore size to sift impurities and/or by chemical binding impurities to the hydrophilic porous media. The hydrophobic barrier can generate at least one of a lateral directional flow and/or a vertical directional flow. At least one hydrophobic detection reagent may be provided within a hydrophilic region, where a hydrophobic detection reagent can be configured to convert from hydrophobic to hydrophilic upon contact with a chemical promoter and/or modify wetting properties of a hydrophilic region upon contact with a chemical promoter.

A responsive reagent may be provided within an assay channel and/or a control channel, where at least one responsive reagent can be configured to, in response to presence and/or absence of a target analyte, produce a chemical promoter, not produce a chemical promoter, or produce the a chemical promoter in amounts and/or at rates distinguishable within an assay channel as compared to a control channel.

The apparatus can be configured to determine a presence and/or concentration of a target analyte within a sample when the sample is introduced into a sample addition port. This may be achieved by causing fluid of a sample to move at differential rates due to the differential amounts and/or rates of chemical promoter produced within the assay channel and/or the control channel. The movement of fluid may be by wicking via capillary action.

In some embodiments, at least one detection region can be hydrophilic. Furthermore, an apparatus may be configured to have an assay channel and a control channel directed towards a detection region so that a sample, after being introduced into a sample addition port, is split into at least a first sample-portion and a second sample-portion, where the sample-portions can be differentially driven towards the at least one detection region: A signal may be generated when a sample-portion contacts a detection region.

Depending upon the selected readout method, the sample-portions can be made to remain separated and may be recombined in at least one flow layer following interaction with a hydrophobic detection reagent and prior to entering a detection region. Additionally, or in the alternative, sample-portions can be made to remain separated and may be recombined within a detection region. If sample-portions are made to remain separated, a time difference between detection signals can be measured, which can be used to determine analyte concentrations. This may be done due to a time difference being proportional to an analyte concentration(s) in a sample. If sample-portions are recombined, a relative distance travelled by each sample-portion within a flow layer and/or detection region can be used to determine analyte concentrations. This may be done due to the relative distance travelled by each sample-portion being proportional to an analyte concentration(s) in a sample.

A casing of an apparatus can include a lower portion and an upper portion, where each portion may be used to support internal structural components of an apparatus and facilitate operation thereof. A lower portion and an upper portion may be configured to engage each other so as to encase at least some internal structural components and be held together via a fastening mechanism.

Some embodiments may include a plurality of the hydrophilic, porous media and/or a plurality of the flow layers. The plurality of media and/or layers can be held in contact with each other via a retention means, which can be used to maintain physical contact between the plurality of media and/or flow layers. A retention means can be further configured to maintain alignment of the media and/or layers.

At least one coloring agent may be provided within a hydrophilic region of at least one of an assay channel and/or a control channel. A coloring agent can be used to generate a detection signal. A detection signal can be directly observed by a user and/or be converted from an optical signal to an electrical signal via an optical reader. Alternatively, or in addition, at least one electrolyte can be provided within a hydrophilic region of at least one of an assay channel and/or a control channel. Furthermore, at least one electrical contact may be provided within a detection region, and an electrical contact can be further configured to generate an electrical signal as a detection signal.

In some embodiments, an electrical output from an optical reader may be temporarily or permanently placed into electrical communication with an electronic detection device, where an electronic detection device can be used to quantify and/or illustrate a detection signal received from a detection region. In some embodiments, a coloring agent can travel with a sample, changing the color of a detection region to quantify and/or illustrate a detection signal. A change in color may be measured by an optical reader in conjunction with an electronic device, indicating a change in color (e.g., measured as a change in the reflected light) above a pre-determined threshold level. When a detection region changes color above a measured threshold level, an optical reader in conjunction with an electronic device can be further configured to measure a time for a portion of the detection region to change color above the threshold level.

In some embodiments, a detection region and an electrical contact can be temporarily or permanently placed into electrical communication with an electronic detection device, where an electronic detection device may be configured to quantify and/or illustrate a detection signal received from a detection region. In a detection region, an electrolyte can travel with fluid of a sample, making a detection region conductive, which may be used to quantify and/or illustrate a detection signal. A change in conductivity can be measured by an electronic device, indicating a change in conductivity (e.g., measured through the resistance) by a pre-determined threshold value. When a detection region becomes conductive above a measured threshold value, an electronic device can measure a time for a portion of the detection region to become conductive above the threshold value.

At least one of an assay channel and/or a control channel can be provided with an offset to skew travel distance and/or travel rate of fluid moving through an assay channel and/or a control channel. An offset can be provided for by at least one of: (i) a distance-offset travelled to a detection region; (ii) specific configuration of a hydrophobic barrier; (iii) setting material and physical properties of a hydrophilic region; and/or (iv) configuring polymers to depolymerize at selected hydrophilic regions and/or hydrophobic barriers. At least one pad can be placed into fluid communication with a sample addition port and a flow layer, where a pad may be provided with a de-contamination reagent.

In some embodiments, a hydrophilic porous media may be derivatized with at least one selectively binding responsive reagent to interact with a target analyte. Other embodiments may include additional reagents to: (i) detect analytes; (ii) modify a pH of a sample; (iii) modify wetting properties a hydrophilic, porous medium; (iv) generate supplementary reagents for selective use of the apparatus; and/or, (v) interact with other responsive reagents to initiate a signal transduction pathway.

Embodiments may further provide describe a new class of polymers/oligomers that provide a sensitive and selective response to a stimulus for use as diagnostic assays. It will be understood that the use of these polymers is not limited to the assays as reported herein, and that other uses may be recognized by one of skill in the art. The assays comprise polymers that depolymerize autonomously in response to specific signals. In preferred embodiments, the signals are molecular signals. In preferred embodiments, the stimulus signal is generated as a result of a specific detection event. These detection events can be, but are not limited to, antibody-antigen binding events, antibody-antigen unbinding events, aptamer-analyte binding events, aptamer-analyte unbinding events, activation of an enzyme, deactivation of an enzyme, or a combination thereof. In a preferred embodiment, the polymer/oligomer used in the diagnostic assay is hydrophobic. In a preferred embodiment, the autonomous, selective depolymerization of the polymer/oligomer converts the hydrophobic polymer/oligomer to hydrophilic products, including, but not limited to, small molecules, dimers, trimers, short oligomers, or a combination thereof.

These potential advantages are made possible by the technical solutions offered herein, yet they are not required to be achieved. The presently disclosed apparatus may be configured to achieve technical advantages, whether or not these potential advantages, individually or in combinations, are sought or achieved.

### BRIEF DESCRIPTION OF THE FIGURES

Exemplary embodiments are best understood from the following detailed description when read in conjunction with the accompanying drawings. Included in the drawings are the following figures:

FIG. 1 is a perspective view of an exemplary first embodiment of an apparatus with an upper portion removed, which may be used to facilitate recombination of split sample portions prior to entering a detection region.

FIG. 2A is a perspective view of an exemplary first embodiment showing an apparatus and its constituent parts.

FIG. 2B is a superimposed layered illustration of an exemplary first embodiment of FIG. 2A.

FIG. 2C is a perspective view of a first exemplary embodiment showing an offset detection region that may be used with an apparatus.

FIG. 2D is a superimposed layered illustration of an exemplary first embodiment of FIG. 2C.

FIGS. 3A-3C are a perspective view with an upper portion removed, a perspective view showing constituent parts, and a superimposed layered illustration, respectively, of an exemplary second embodiment of an apparatus.

FIGS. 4A-4C are a perspective view with an upper portion removed, a perspective view showing constituent parts, and a superimposed layered illustration, respectively, of an exemplary third embodiment of an apparatus.

FIGS. 5A-5B are a perspective view with an upper portion removed of an exemplary fourth embodiment and a perspective view of an exemplary fourth embodiment in connection with an electronic detection device, respectively.

FIG. 6 shows a general scheme of a linear depolymerizable poly(benzyl ether).

FIG. 7 shows a linear poly(benzyl ether) with a vinyl boronic ester end-cap.

FIG. 8 shows a linear poly(benzyl ether) with an aryl boronic ester on each repeating unit.

FIG. 9 shows a linear poly(benzyl ether) copolymer containing unfunctionalized repeating units, and repeating units functionalized with aryl boronic esters.

FIG. 10 shows a linear poly(benzyl ether) copolymer containing repeating units functionalized with either aryl boronic esters and/or a different functional group (i.e., OMe, or allyl ether).

FIG. 11 shows a general scheme for a cyclic poly(benzyl ethers).

FIG. 12 shows a cyclic poly(benzyl ether) containing an aryl boronic ester on each repeating unit.

FIG. 13 shows a cyclic poly(benzyl ether) copolymers that containing repeating units functionalized with either aryl boronic esters and/or a different functional group (i.e., OMe, or allyl ether).

FIG. 14 shows an expanded view of the paper device used for optimizing oligomer 1. In one embodiment the device is 10 mm wide×10 mm long×0.6 mm thick.

FIG. 15 shows the effect of the quantity of compound 1 (also referred to as “oligomer 1”) on the measured limit of detection (LOD) for hydrogen peroxide.

FIG. 16 shows a general layout of a lateral flow immunoassay combined with a paper-based device for the quantitative detection of creatine kinase (CK) by measuring time.

FIG. 17 shows a layout of the device used for quantifying creatine kinase. Part (a) of FIG. 17 shows an expanded layout of the lateral flow device. The arrows indicate the flow of sample between different parts of device. The device is 0.5 cm wide×5 cm long×0.8 mm thick. Part (b) of FIG. 17 shows an assembled layout of the lateral flow device, including locations of reagents on the nitrocellulose strip.

FIG. 18 shows a photograph of a single channel lateral flow immunoassay, with attached paper-based device, in a 3-D printed plastic case. The photograph shows two devices, the top device in a closed plastic case and the bottom device in an open plastic case (i.e., no cover).

FIG. 19 shows a calibration curve for CK using the device shown in FIGS. 14 and 1 as the hydrophobic detection reagent. The calibration curves were obtained at 20° C. and 37% relative humidity. The data points represent the average of four measurements and the error bars reflect the standard deviations of these averages.

FIG. 20 shows a two-lane analysis device.

FIG. 21 shows optimization of the concentration of 3 deposited on the nitrocellulose. Each dual channel device was challenged with 300 μL of 4.28 pg/mL CK in buffered water. The optimization curve was obtained at 20° C. and 37% relative humidity. The data points represent the average of four measurements and the error bars reflect the standard deviations of these averages.

FIG. 22 shows optimization of the concentration of 4 deposited on the nitrocellulose. Each dual channel device was challenged with 300 μL of 4.28 pg/mL CK in buffered water. The optimization curve was obtained at 20° C. and 37% relative humidity. The data points represent the average of four measurements and the error bars reflect the standard deviations of these averages.

FIG. 23 shows optimization of the concentration of 5 deposited on the nitrocellulose. Each dual channel device was challenged with 300 μL of 4.28 pg/mL CK in buffered water. The optimization curve was obtained at 20° C. and 37% relative humidity. The data points represent the average of four measurements and the error bars reflect the standard deviations of these averages.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

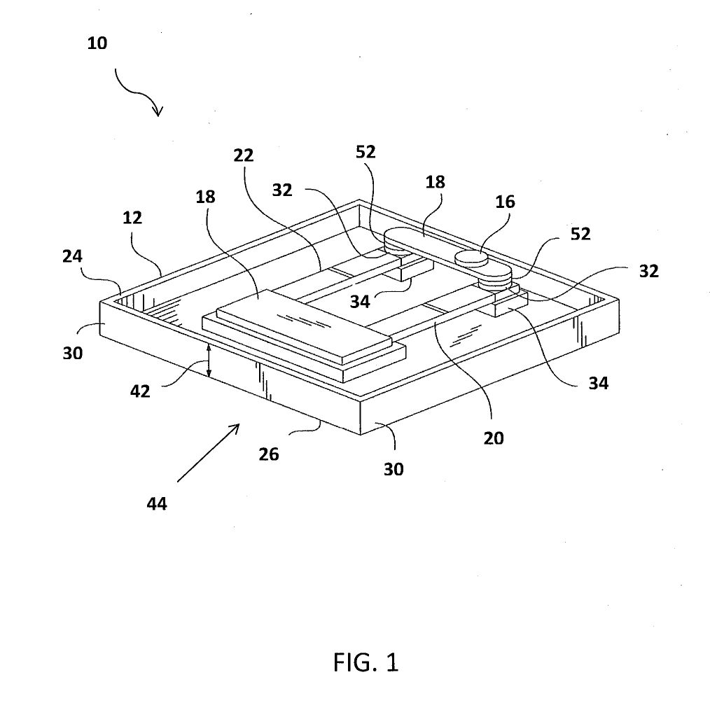

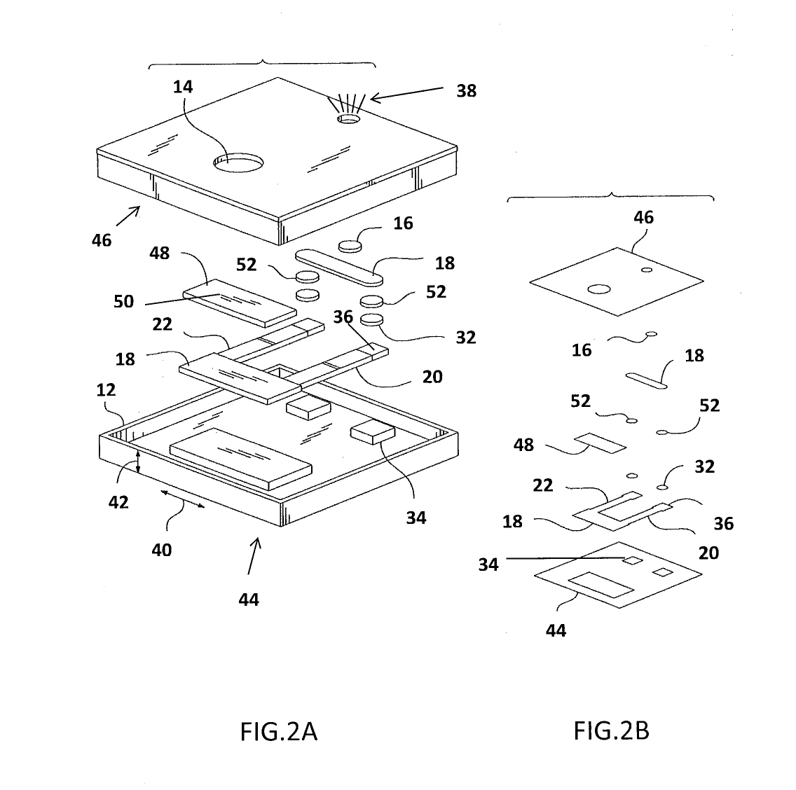

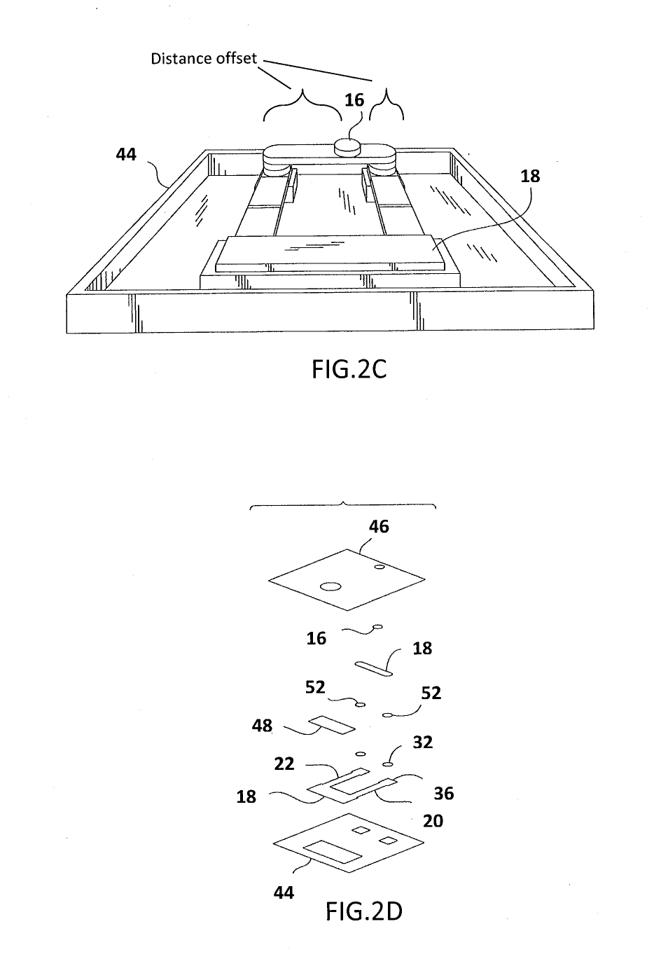

Referring to FIGS. 1 and 2A-2D, embodiments disclosed herein may provide for a portable analytic device (herein referred to as the “apparatus”) 10 comprising a casing 12 with at least one sample addition port 14 in fluid communication with at least one detection region 16 via at least one flow layer 18, at least one assay channel 20, and at least one control channel 22. A casing 12 has a casing upper 24, a casing lower 26, and casing sides 30. A flow layer 18 comprises at least one hydrophilic region and at least one hydrophobic barrier, which can facilitate flow of a fluid from a sample addition port 14 to a detection region 16. Any one of the sample addition ports 14, assay channels 20, control channels 22, and detection regions 16 may contain a flow layer 18. A hydrophilic region comprises a hydrophilic, porous media configured to enable directional flow of fluids, which may be by capillary action, where each hydrophilic region and the directional flow there-through is dictated by a hydrophobic barrier. At least one hydrophobic detection reagent 32 is provided within a hydrophilic region, where a hydrophobic detection reagent 32 is configured to convert from hydrophobic to hydrophilic upon contact with at least one chemical promoter 34. In some embodiments, the hydrophobic detection reagent 32 can respond to hydrogen peroxide to convert from hydrophobic to hydrophilic molecules.

An apparatus 10 may be used to determine the presence and/or concentrations of at least one target analyte within at least one sample. As a sample is introduced into a sample addition port 14, a flow layer 18 absorbs that sample. Capillary action can drive a sample via a flow layer 18 to an assay channel 20 and a control channel 22. At least one responsive reagent 36 is provided within each channel 20, 22, which is configured, in response to the presence/absence of a target analyte, to produce a chemical promoter 34, not produce a chemical promoter 34, or produce a chemical promoter 34 in amounts and/or at rates distinguishable at one channel 20, 22 as compared to another channel 20, 22.

While still in an assay channel 20 and a control channel 22, capillary action may continue to drive a sample and chemical promoter 34, if any chemical promoter 34 is produced, towards a detection region 16. Before reaching a detection region 16, however, a sample encounters a hydrophobic detection reagent 32. If a chemical promoter 34 is present, a hydrophobic detection reagent 32 converts to hydrophilic upon contact with a chemical promoter 34. A detection region 16 is also hydrophilic; therefore, a sample-portion contained within an assay channel 20 is “racing” a sample-portion contained within a control assay 22 as they both are driven towards a detection region 16.

An apparatus 10 may, therefore, be configured to generate a conditioned response of producing a chemical promoter 34, not producing a chemical promoter 34, or producing a chemical promoter 34 in certain amounts and with certain rates in the presence/absence of a target analyte. A chemical promoter 34, in turn, converts a hydrophobic detection reagent 32 to hydrophilic. In a channel 20, 22 where a hydrophobic detection reagent 32 converts to hydrophilic, the wicking occurs at a faster rate as contrasted with a channel 20, 22 where a hydrophobic detection reagent 32 has not been converted to hydrophilic. This differential in wicking rates is exploited to determine the presence/absence and/or concentrations of a target analyte because a sample is differentially driven towards a detection region 16 via the channels 20, 22. As will be explained below, several techniques are employed to utilize the differential wicking rates and provide a detection signal 38 at the detection region 16 indicative of presence/absence and/or concentrations of a target analyte in a sample.

In some embodiments, regions treated with detection reagent 32 can be made to alter the porous media to inhibit the flow of fluid through a flow layer 18 (e.g., become hydrophobic) when hydrogen peroxide is not present within the sample. When hydrogen peroxide is present, the detection reagent 32 can be made to convert to hydrophilic byproducts, switching the porous media from hydrophobic to hydrophilic. The rate that a sample is able to convert a detection reagent 32 to hydrophilic can depend on the concentration of hydrogen peroxide in the sample, thereby correlating the time for the sample to wick through the one or more of the flow layers 18 treated with the detection reagent 32 to the concentration of hydrogen peroxide.

The channels 20, 22 and the flow layer 18 are configured to enable lateral flow 40, vertical flow 42, or both 40, 42 with respect to a casing upper 24 and a casing lower 26. While it is illustrated in the figures for a casing 12 to be a planar object having a polygonal shape, it is understood that the casing 12 may have any shape or ornamental design without deviating from the teachings of the apparatus 10. A significance of a casing upper 24, lower 26, and sides 30 is to define lateral and vertical flows, and it is therefore understood that a casing 12 need not necessarily have a structural upper component, a structural lower component, or structural side components.

Lateral flow 40 is defined as directional movement that necessitates, on average, traversing a distance from a first side to a second side that is longer than a distance traversed from a casing upper/lower to a casing lower/upper in order to complete a travel path. Vertical flow 42 is defined as a directional movement that necessitates, on average, traversing a distance from a casing upper/lower to a casing lower/upper that is longer than a distance traversed from a first side to a second side in order to complete a travel path. Therefore, under lateral flow 40 the path traversed is substantially side to side, and under vertical flow 42 the travel path traversed is substantially from casing upper/lower to casing lower/upper.

The lateral flow 40 and vertical flow 42 configurations, or combinations thereof, enable added control of flow/wicking rates and reaction times. One skilled in the art could envisage some situations that would dictate or necessitate faster/slower flow/wicking rates and/or faster/slower reaction times within a flow layer 18 and/or a channel 20, 22 to provide greater sensitivity and functionality, which could be achieved with the arrangement of vertical flows 42 and lateral flows 40. While it is envisioned that vertical flows 42 would tend to provide for faster flow/wicking rates than lateral flows 40, it is understood that a myriad of vertical/lateral flow schemes and configurations may be employed to adapt an apparatus 10 for specific flow/wicking rates.

In some embodiments, an analyte may be quantified by measuring time using a timer (digital or analog). This may be achieved by measuring time using a fluidic timer. A fluidic timer can include, but is not limited to, regions of an apparatus 10 modulated with a hydrophobic molecule (e.g., paraffin wax) that can affect the wicking properties of the region. For example, variations in the quantity/type or hydrophobic molecule can allow for control over the time for a sample to wick through an apparatus 10. The analyte may be quantified by counting colored assay regions at a fixed assay time. As explained above, an apparatus 10 can include at least one responsive reagent 36 configured to contact a sample so that the responsive reagent 36 specifically targets the analyte and interacts with a detection reagent 32 to produce a response. A responsive reagent 36 can be selected to react with the analyte and produce hydrogen peroxide, which can convert a detection reagent 32 from hydrophobic to hydrophilic. A responsive reagent 36 may be a small-molecule substrate, an enzyme, a substrate-enzyme complex, an aptamer-enzyme-substrate complex, etc. A plurality of different responsive reagents 36 may be included in a same flow layer 18.

In some embodiments, a sample may be wicked to a flow layer 18 containing a coloring agent 52 (e.g., dye), redissolving the dye and becoming colored. The colored sample solution can then wick to a detection region 16, providing a colored indication of when the assay is complete within that channel 20, 22. The concentration of analyte within the sample can be determined by counting the number of channels 20, 22 where a color change is visible in the detection region 16 after a fixed assay time has elapsed (e.g., 5, 10, or 15 minutes). For example, an apparatus 10 can be structured such that as a sample is wicked through a flow layer 18 it can encounter a flow layer 18 that has been treated with a dye, allowing the sample to be visualized. The colored sample can continue to wick to a detection region 16, causing the flow layer 18 of the detection region 16 to change color. The elapse of time from addition of the sample into a sample addition port 14 to the change in color of the detection region 16 can be used as the “assay time,” which can correlate to the concentration of hydrogen peroxide within the sample.

Furthermore, the differential flow/wicking rates and reaction times of the vertical flows 42 and lateral flows 40 provide a means to configure an apparatus 10 to function as a multiplex assay, which enables detecting and analyzing multiple target analytes simultaneously and independently from each other. Therefore, while exemplary embodiments may describe a single sample, a single target analyte, and structural components/channels/layers/media/chemicals in singular, it is understood that a plurality thereof may be utilized and that any description of singulars is done for the sake of ease of illustration and brevity. It is understood that the same reference may include the singular or plurality of that component/element without deviating from the teachings of the apparatus 10. Where multiple layers and components are employed, the casing 12 and retention means described herein hold the components and layers together and in alignment.

In an exemplary embodiment, a casing 12 comprises a structural component fabricated from a light-weight rigid material. This may be, for example, plastic. Other similar materials may be utilized, for example, fiberglass, aluminum, steel, etc. While a casing 12 is shown as preferably having a lower portion 44 and an upper portion 46 to encase the internal structural components within, it is not necessary limited to such a configuration. Any configuration that enables a casing 12 to support the internal structural components and facilitate operation of those internal structural components consistent with the disclosure herein may be utilized. Where lower and upper portions 44, 46 are utilized, it is envisioned for the portions to engage each other so as to encase the internal components of an apparatus 10 and be held together via a fastening mechanism. This may be, for example, an interference fit, adhesive bonding, threading engagement with a screw, or the like.

In some embodiments, an apparatus 10 can be made from hydrophilic, porous media patterned with hydrophobic barriers and layers of adhesive material, which may be stacked in alternating order (e.g., 2 to 6 layers). Protective coatings (e.g., laminate) can be used to seal lower and upper portions 44, 46 together with an aperture in a top layer of the protective coating to allow for sample addition.

It is envisioned for an apparatus 10 to be configured as a hand-held device and comprise cost-effective materials so as to enable portability and disposability; however, an apparatus 10 may be of any size and may be configured to be reusable.

In an exemplary embodiment, a hydrophilic porous media comprises paper because it exhibits properties of being inexpensive, disposable, wicks rapidly, and obviates special handling procedures. Other hydrophilic porous media may be utilized. These may include felt, cotton, polypropylene, and the like. Some embodiments comprise more than one hydrophilic porous media, different types of hydrophilic porous media, and/or multiple hydrophilic porous media layers. The layers can be the same, alternating, and/or structured in any other type of arrangement. In such embodiments, hydrophilic, porous media layers are held in contact through a retention means. This may be, for example, a spray adhesive, a laminate, or a double-sided tape. Other retention means may be utilized. For example, an apparatus 10 may be utilized to maintain physical contact between multiple hydrophilic porous media via pressure provided by physical engagement of a casing lower portion 44 and casing upper portion 46.

Porous, hydrophilic media can be patterned with hydrophobic barriers for performing assays on fluids. The paper or other porous, hydrophilic medium can be patterned with hydrophobic barriers that provide spatially defined regions for fluid transport based on capillary action. These hydrophobic barriers, such as wax, can provide an impermeable barrier throughout the entire thickness of the porous, hydrophilic medium within defined areas. The regions defined by the hydrophobic barriers can contain the hydrophilic, porous medium, rather than being empty as is common in glass or polymeric (PDMS) microfluidic devices. For example, fluid can be made to flow from one flow layer 18 to another, constrained by the patterned hydrophobic barriers. A plurality of the defined areas of porous, hydrophilic medium can be treated prior to assembly of the apparatus 10 to provide an assay for a target analyte.

In an exemplary embodiment, a hydrophobic barrier comprises patterns of hydrophobic material forming micro-channels, wells, regions, reservoirs, and the like that serve as guides for directional flow (e.g., vertical, lateral, or otherwise). It is envisioned for a hydrophobic barrier to be fabricated from, but is not limited to, photoresist, polystyrene, polydimethylsiloaxane, wax, or any combination/permutation thereof. Alternatively, a hydrophilic porous media may be functionalized, which may be achieved with nitrocellulose, and then physically patterned, which may be achieved by CO₂ laser cutting, to form a hydrophobic barrier. In this embodiment, it is envisioned for a hydrophilic region to be created prior to assembly of an apparatus 10.

In an exemplary embodiment, a responsive reagent 36 comprises reagents that provide a chemical promoter 34 upon contact, or in the absence of contact, with a target analyte. Chemical promoters 34 may include hydrogen peroxide, thiol, or the like. A responsive reagent 36 may include, but is not limited to: 1) a small-molecule substrate; 2) an enzyme; 3) a substrate-enzyme complex; 4) an aptamer-enzyme-substrate complex; an antibody-enzyme-substrate complex; 5) and, any combination/permutation thereof.

In an exemplary embodiment, a hydrophobic detection reagent 32 comprises reagents with molecules, oligomers, or polymers that change from hydrophobic to hydrophilic upon contact with a chemical promoter 34. It is understood that it is neither necessary for each molecule nor a substantial portion of the molecules of a hydrophobic detection reagent 32 to convert to hydrophilic upon contact with a chemical promoter 34, but that a change of enough molecules occurs to generate a desired hydrophilic effect. A hydrophobic detection reagent 32 can be a responsive small molecule, oligomer or polymer, including, but not limited to, carbamate, ether, polyether, poly(phthalaldehyde), polyvinyl carbamates, other polycarbamates (e.g., polybenzyl carbamates), or any combination/permutation thereof.

In an exemplary embodiment, at least one pad 48 is placed into fluid communication with a sample addition port 14 and a flow layer 18. A pad 48 is preferably disposed within a casing 12; however, it need not be placed with a casing 12. A pad 48 is envisioned to be absorbent and porous, and provided with at least one de-contamination reagent 50. A de-contamination reagent 50 may be configured to remove contaminants from a sample, where a pad 48 is configured to trap those contaminants as a sample continues to wick towards a flow layer 18. The de-contamination pad 48 may be a material such as glass-fiber paper (e.g., glass-fiber conjugate pad), containing immobilized glucose oxidase and/or immobilized catalase, in order to remove contaminants such as glucose and/or hydrogen peroxide.

In an exemplary embodiment, at least one coloring agent 52 may be provided within a hydrophilic region of an assay channel 20 and/or a control channel 22. A coloring agent 52 may be, for example, a dye, a pigment, or other substance that imparts color. As a sample is wicked into the channels 20, 22, a coloring agent 52 dissolves and is carried along with a sample as wicking continues. When at least one assay channel 20 and at least one control channel 22 are recombined prior to the detection region 16, the sample-portions contained within them “race” to that detection region 16. A “winning” sample-portion provides a detection signal 38 in the form of a visual indicator at a detection region 16 for a user and/or optical reader to observe. When at least one assay channel 20 and at least one control channel 22 are recombined within the detection region 16, the sample-portions will advance toward one another and eventually recombine. The lateral position at which the sample-portions converge provides a detection signal 38 in the form of a visual indicator for a user and/or optical reader to observe. In an alternative embodiment, a plurality of coloring agents 52 are employed, where a coloring agent 52 utilized in an assay channel 20 contrasts in visual color with a coloring agent 52 utilized in a control channel 22.

In an alternative embodiment, appropriate salts are incorporated with the coloring agents 52, with each sample-portion dissolving and carrying a different salt. Salts are chosen such that upon convergence of the sample-portions containing coloring agents 52 and appropriate salts, insoluble salts are formed and further advancement and mixing of sample-portions containing coloring agents 52 is halted to facilitate readout. Examples of salt pairs which can be used include potassium carbonate and sodium tetraphenylborate, zinc chloride or manganese chloride or iron(II) chloride or copper chloride or calcium chloride and sodium carbonate, and magnesium chloride and sodium phosphate.

While a coloring agent 52 is envisioned to provide a visual detection signal 38 via display of light in the visible light spectrum, it is understood that other light emitting/absorbing agents may be utilized to emit/absorb light outside of the visible light spectrum of which may be detected by other means.

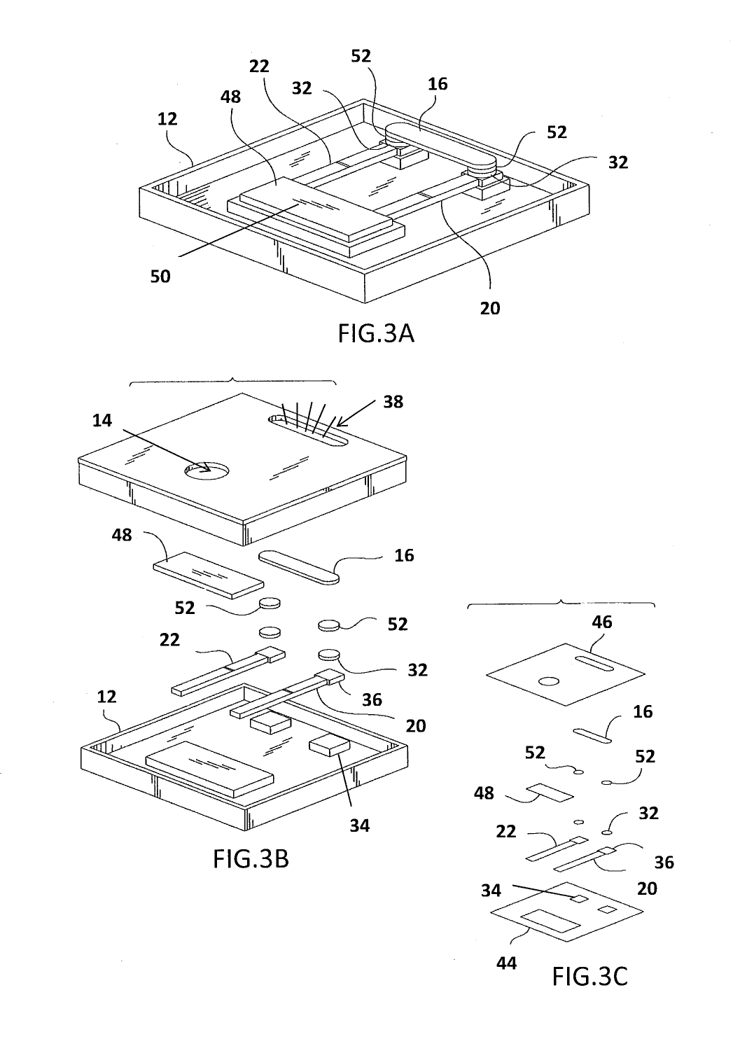

In an exemplary second embodiment, a lateral flow layer 18 can be used as a detection region 16 to configure an apparatus 10 to generate semi-quantitative analytics of as assay. (See FIGS. 3A-C). For example, as a sample continues to wick, it does so towards a region of a flow layer 18 that may contain a coloring agent 52 and a salt. The colored-salted solutions can be made to wick laterally toward one another within a detection region 16. A detection region 16 can be exposed, or otherwise made available for observation, through an elongated aperture in a casing 12 of an apparatus 10. An assay channel 20 and control channel 22 can contain coloring agents 52 of contrasting color, and the concentration of an analyte may be approximated by the lateral position of convergence of the colored sample-portions within a detection region 16.

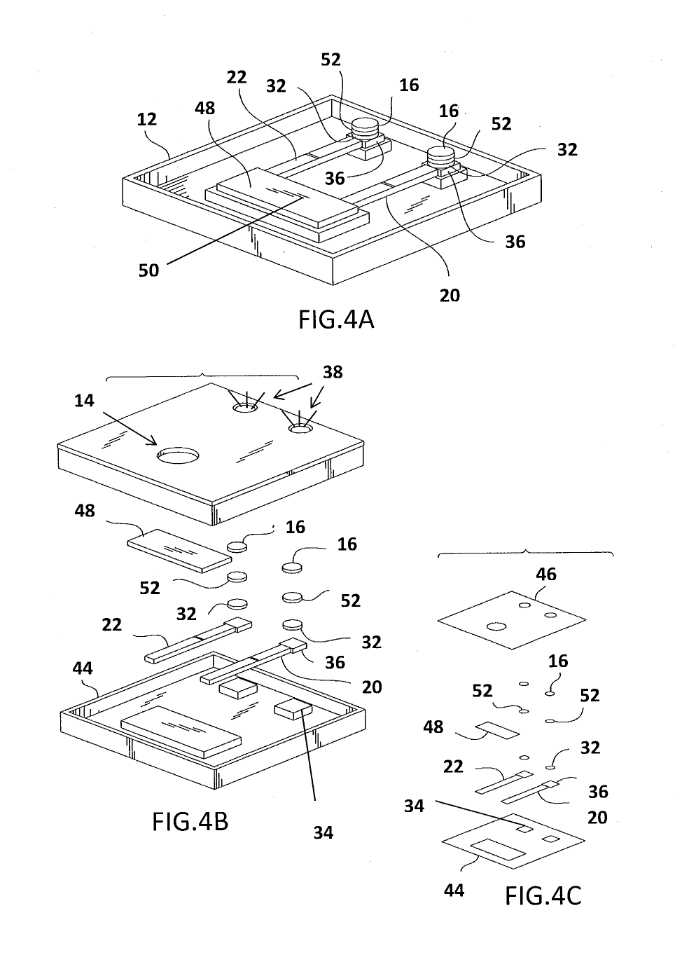

In an exemplary third embodiment, an apparatus 10 can be configured to generate quantitative analytics of an assay, which can be done through use of an optical readout. (See FIGS. 4A-4C). For example, colored sample-portions may be monitored within a detection region 16 using an optical reader. An optical reader may include an emitter such as a light emitting diode and a photodetector such as a photoresistor. Light from an emitter can be directed toward a detection region 16 of each channel 20, 22, where a photodetector may be used to measure reflected light. As sample-portions racing to reach a detection region 16, a winning sample-portion that reaches a detection region 16 first produces a first detection signal 38.

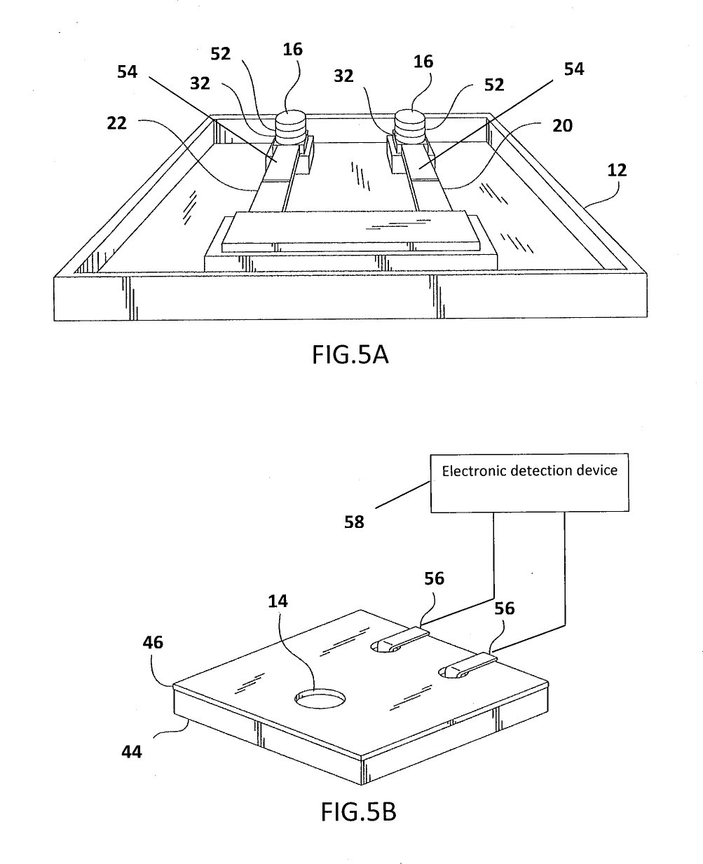

In an exemplary fourth embodiment, at least one electrolyte 54 may be provided within a hydrophilic region of an assay channel 20 and/or control channel 22. (See FIGS. 5A-5B). This may be done to configure an apparatus 10 to be used with a conductometric readout. An electrolyte 54 may include, for example, buffer salt, HEPES, phosphate buffer, phosphate-buffered saline, conductive salt, metal ions, conductive organic molecules, or any combination/permutation thereof. As a sample is wicked into the channels 20, 22, an electrolyte dissolves and is carried along with a sample as wicking continues. Because, in some embodiments, at least one assay channel 20 and at least one control channel 22 may be directed to a single detection region 16, the sample-portions contained within them “race” to a detection region 16. A detection region 16 in this embodiment is provided with at least one electrical contact 56, preferably configured as an electrode, that is enabled to transmit electrical current in a form of an electrical signal to an electronic detection device 58. This may be achieved with the use of copper tape or other conductive material as an electrode. It is envisioned for a detection region 16, along with an electrical contact 56, to be configured to be temporarily placed into electrical communication with an electronic detection device 58 through the use of a universal serial bus port or 3.5 mm phone connector socket; however, any electrical connector common in the art may be utilized.

An electronic detection device 58 may comprise a system of solid-state relays or timers, a computer, a portable electronic device (e.g., a smartphone), a volt-ammeter with electronic relays, or the like. An electronic detection device 58 may alternatively be integral to a disclosed apparatus 10 by being in permanent electrical communication with an apparatus 10. An electronic detection device 58 may also be affixed, temporarily or permanently, to a surface of a disclosed apparatus 10. Alternatively, an apparatus 10 may be configured to affix, temporarily or permanently, to a surface of an electronic detection device 58. In any embodiment, an electronic detection device 58 can be provided with a readout, display, or gauge to quantify and/or illustrate a detection signal received.

It will be understood by one skilled in the art, with the benefit of this disclosure, that various arrangements, configurations, and schemes of casings 12, flow layers 18, vertical flows 42, lateral flows 40, channels 20, 22, hydrophilic regions, hydrophobic barriers, retention means, fastening mechanisms, chemical promoters 34, reagents, coloring agents 52, electrolytes 54, and materials and chemicals comprising the same may be used to modify flow rates, reaction times, kinetics, and other material, chemical, and physical properties to improve functionality and sensitivity of a disclosed apparatus 10.

For instance, changes of the quantity of detection reagent 32 may affect the sensitivity of an apparatus 10. Thus the quantity of a detection reagent 32 can be altered to tune the sensitivity of an apparatus 10. As by way of another example, a detection region 16 and/or color agent 52 may be configured to display a color of a color agent 52 for a predetermined period of time. This may be, for example, thirty minutes, sixty minutes, or one-hundred twenty minutes. This may be achieved by providing a color agent 52 with a predetermined oxidation rate. As by way of further example, an apparatus 10 may be configured to provide a detection signal 38 within a predetermined period of time after a sample has been added to a sample addition port 14. This may be, for example, ten minutes, fifteen minutes, twenty minutes, or thirty minutes. This may be achieved by modifying flow rates as described above.

At least one assay channel 20 or at least one control channel 22 may be provided with an offset to skew, or otherwise favor, travel distance and/or travel rate of fluid moving through that particular channel 20, 22 as contrasted with another channel 20,22. This offset may be achieved by, but is not limited to, providing a distance-offset travelled to a detection region 16, specific configuration of pattern arrangements of a hydrophobic barrier, setting material and physical properties of a hydrophilic region, configuring polymers to depolymerize at certain regions/barriers, or any combination/permutation thereof.

In a preferred embodiment with the utilization of a color agent 52, and as by way of example, an apparatus 10 may be configured in a following manner. As a sample is added to a sample addition port, a sample encounters a pad 48 containing a de-contamination reagent 50 for removing contaminants from a sample. Capillary action may drive a sample from a pad 48 to a first flow layer, which is configured as a lateral flow layer. Capillary action may further drive a sample to a region containing a responsive agent 36, then to an assay channel 20 and a control channel 22, where it encounters additional responsive agents 36 in each channel 20,22. The responsive reagent 36 encountered is identical for both the assay channel 20 and control channel 22. The sample will react with the responsive reagent 36 in both the vertical flow 42 and lateral flow 40 regions, increasing the incubation time of the sample and responsive reagent 36, and by doing so, increasing the sensitivity of the assay.

While in a control channel 22, an additional responsive reagent 36 is configured to react to the presence of a target analyte to produce hydrogen peroxide. An additional responsive reagent 36 in the assay channel 20 is configured to produce less hydrogen peroxide in the presence of a target analyte than does a responsive reagent 36 of a control channel 22. This may be achieved by producing a lesser absolute amount of hydrogen peroxide in an assay channel 20 or producing hydrogen peroxide at a slower rate in an assay channel 20. In the absence of a target analyte, the same amount of hydrogen peroxide, or substantially the same, is produced in both channels 20, 22.

Capillary action may continue to drive a sample from a first flow layer to at least one additional flow layer, where an additional responsive reagent 36 in both the assay channel 20 and control channel 22 is configured to provide similar effects on sample wicking rates when interacting with a sample. However, within at least one of the additional flow layers 18 is a hydrophobic detection reagent 32, and as a sample contacts this hydrophobic detection reagent 32, a hydrophobic detection reagent 32 is converted to hydrophilic in the presence of hydrogen peroxide. In this embodiment, an assay channel 20 is configured to produce less hydrogen peroxide in the presence of a target analyte, causing less hydrophobic detection reagents 32 to convert to hydrophilic, which causes a sample-portion within an assay channel 20 to wick at a slower rate towards a detection region 16 than does a sample-portion within a control channel 22.

In an alternative embodiment, an additional responsive reagent 36 in a control channel 22 is configured to react to the presence of a target analyte to not produce hydrogen peroxide, whereas an additional responsive reagent 36 in an assay channel 20 is configured to produce hydrogen peroxide in the presence of a target analyte. In the absence of the target analyte, an additional responsive reagent 36 in the assay channel 20 is configured to not produce hydrogen peroxide, similar to the control channel 22. In this embodiment, a control channel 22 is configured to produce no hydrogen peroxide in the presence of a target analyte, which causes a sample-portion within a control channel to wick at a slower rate towards a detection region 16 than does a sample-portion within an assay channel 20.

As a sample continues to wick, it does so towards a region of a flow layer 18 containing at least one coloring agent 52, redissolving the at least one coloring agent 52. The assay channel 20 and control channel 22, each have different, contrasting coloring agents 52 that are easily distinguishable. A sample continues to wick to a lateral flow channel, which connects an assay channel 20 and a control channel 22. The colored solutions, comprising the sample-portions along with the at least one coloring agent 52, wick laterally, “racing” to reach a detection region 16. A layer of the detection region 16 is exposed, or otherwise made available for observation, so that the change in color of a detection region 16 (due to the color of the “winning” sample-portion laden with the at least one coloring agent 52 solution) provides a detection signal 38. Because an assay channel 20 has a coloring agent 52 that contrasts in color to the coloring agent 52 in a control channel 22, the presence/absence of an analyte may be determined by the coloring agent 52 observed at a detection region 16. A sample-portion that reaches a detection region 16 first generates a color due to the coloring agent 52, which indicates the presence/absence of a target analyte.

In an alternative embodiment, as a sample continues to wick, it does so towards a region of a flow layer 18 containing at least one coloring agent 52 and salt, redissolving the at least one coloring agent 52 and salt. The assay channel 20 and control channel 22, each have different, contrasting colored coloring agents 52 that are easily distinguishable and have different complimentary salts. A sample continues to wick to a lateral flow channel, which connects an assay channel 20 and/or a control channel 22. The colored salt solutions, comprising the sample-portions along with the at least one coloring agent 52 and salt, wick laterally toward one another within the detection region 16. The detection region 16 is exposed, or otherwise made available for observation, so that the at least one coloring agent-containing sample-portions can be visualized. Because the assay channel 20 and control channel 22 contain coloring agents 52 of contrasting color, the concentration of an analyte may be approximated by the lateral position of convergence of the colored sample-portions within the detection region 16. Due to the formation of insoluble salts upon convergence of the sample-portions that may prevent mixing of coloring agents 52, this determination may be made immediately upon convergence or at a later time.

With or without salts, colored sample-portions may be monitored within the detection region 16 using an optical reader. The optical reader comprises an emitter such as a light emitting diode and a photodetector such as a photoresistor. Light from the emitter is directed toward the detection region 16 at the surface of the apparatus 10, and the photodetector is configured to measure reflected light. As sample-portions wick laterally, “racing” to reach a detection region 16, the “winning” sample-portion that reaches a detection region 16 first produces a first detection signal 38 (e.g., reduction in reflected light measured by the photodetector due to absorbance by the coloring agent 52), which is communicated to an electronic detection device 58. As a subsequent sample-portion, and any successive sample-portions thereof, reach a detection region 16, a second detection signal 38, and any successive detection signals 38, is/are produced and communicated to an electronic detection device 58. The time durations between detection signals 38 may be determined and recorded by an electronic detection device 58, which may be used to determine concentrations of a target analyte within a sample.

In a preferred embodiment with the utilization of the electrolyte 54, and as by way of example, an apparatus 10 may be configured in a following manner. With or without the color agent 52, a sample may be wicked to a region of a flow layer 18 containing conductive salt (e.g., sodium chloride “(NaCl”)). The NaCl may be disposed before the coloring agent 52, after the coloring agent 52, within the coloring agent 52, or in the coloring agent's 52 stead, whereby the sample-portions of an assay channel 20 and a control channel 22 become conductive upon mixing with the NaCl. As the sample continues to wick, it does so towards a lateral flow channel, which connects the assay channel 20 and control channel 22. The conductive solutions, comprising sample-portions laden with NaCl, and with or without the coloring agent 52, wick laterally, “racing” to reach a detection region 16. A layer of a detection region 16 is provided with at least one electrode (e.g., copper tape) so that electrical current is generated in the electrode when a sample-portion laden with NaCl contacts the electrode.

A “winning” sample-portion laden with NaCl that reaches a detection region 16 first produces a first detection signal 38 by either opening or closing a circuit, which is communicated to an electronic detection device 58. As a subsequent sample-portion laden with NaCl, and any successive sample-portions thereof, reach a detection region 16, a second detection signal 38, and any successive detection signals 38, is/are produced and communicated to an electronic detection device 58. The time durations between detection signals 38 may be determined and recorded by an electronic detection device 58, which may be used to determine concentrations of a target analyte within a sample.

In a preferred embodiment with the utilization of a filtering hydrophilic, porous media, and as by way of example, an apparatus 10 may be configured in a following manner. A flow layer 18 may be configured to remove impurities from a sample that may affect operation and functionality of an apparatus 10. The impurities removed may be physical (e.g., dirt) or chemical (e.g., glucose). A hydrophilic, porous media used in a flow layer 18 may be configured as a filter by selecting pore size of a hydrophilic porous media to filter particles of certain size (e.g., red blood cells) from a sample.

Alternatively, or in addition thereto, treatment of a hydrophilic, porous media can bind, or otherwise remove, small chemical impurities that cannot be removed based on size. For instance, a hydrophilic, porous media may be treated with immobilized glucose oxidase and immobilized catalase. Any glucose that is present within a sample is converted to hydrogen peroxide by the glucose oxidase, where the generated hydrogen peroxide will then be decomposed by the catalase, thereby eliminating glucose from a sample. This same setup enables removal of background hydrogen peroxide within a sample as well. As by way of example, enzymes may be immobilized either through chemical modification of a hydrophilic, porous media and/or through coupling (e.g., biotin-streptavidin) with large particles (e.g., ˜10 μm polystyrene particles). The pore size of a hydrophilic, porous media can then prevent movement of the immobilized enzymes between flow layers 18. For example, the immobilized glucose oxidase could convert the glucose generated by the target enzyme into hydrogen peroxide. The size of the polystyrene particles can prevent the glucose oxidase from travelling with the solvent of the sample, minimizing the amount of protein present within the sample (high levels of protein can affect the viscosity and wicking rate of a liquid).

In an exemplary embodiment, regions of the hydrophilic, porous media may be derivatized with at least one selectively binding responsive reagent 36. These may include, for example, small molecules, signal transduction molecules, substrates, aptamers, antibodies, or proteins, to interact with a target analyte. This may be done to detect a target protein (e.g., rabbit Immunoglobulin G (“rabbit IgG”). For example to detect hydrogen peroxide, a region of the hydrophilic medium can be derivatized with a hydrophobic small molecule detection reagent 32 that selectively reacts with hydrogen peroxide. The presence of the hydrophobic detection reagent 32 can modify the wetting properties of the region, converting the hydrophilic, porous medium to hydrophobic.

A first hydrophilic, porous media region may be derivatized with a first selectively binding responsive reagent 36 that selectively binds to a target protein (e.g., anti-rabbit IgG antibody labeled with glucose oxidase). As wicking continues, and following the binding of the enzyme-labeled antibody to a target protein, a sample encounters a second hydrophilic, porous media region derivatized with a second selectively binding responsive reagent 36 (e.g., anti-rabbit IgG antibody) immobilized on a surface of the second region. Binding of a target protein to a second antibody results in a decrease of glucose oxidase concentration in solution. A sample then encounters a third hydrophilic, porous media region containing glucose, which reacts with the glucose oxidase in solution to produce hydrogen peroxide. The hydrogen peroxide encounters a fourth hydrophilic, porous media region derivitized with a hydrophobic small molecule detection reagent 32 that selectively reacts with hydrogen peroxide. The presence of a hydrophobic detection reagent 32 modifies the wetting properties of an assay region, converting the hydrophilic, porous medium in that assay region to hydrophobic. When a hydrophobic detection reagent 32 reacts with hydrogen peroxide, it converts to hydrophilic byproducts, thereby switching the wetting properties of an assay region to hydrophilic.

Preferably, a defined volume of a sample is introduced into an apparatus 10 in order to produce reliable results, especially for quantitative measurements. Patterns of hydrophobic barriers may be configured to generate the micro-channels, wells, regions, reservoirs, etc., that accept only a fixed volume of sample in order to achieve this. The number of flow layers 18 within an apparatus 10 can affect the volume of sample required for the assay to perform optimally. It is contemplated for volumes of sample to be within a range from 8 to 12 .mu.L; however, the sample size can range from 8 to 120 .mu.L.

A wide variety of reagents may be utilized to perform several functions. These may include, but are not limited to: (i) detecting analytes; (ii) modifying the pH of a sample solution; (iii) modifying the wetting properties of a hydrophilic, porous medium; (iv) generating additional reagents necessary for the assay test to be performed; or, (v) interact with other responsive reagents to initiate a signal transduction pathway (e.g., a thiol interacting with a disulfide within another responsive reagent). These reagents can include, but are not limited to, antibodies, aptamers, responsive polymers, proteins, salts, organic small molecules, or any combination/permutation thereof. These reagents could be adsorbed to a porous, hydrophilic media non-covalently (through non-specific interactions) or covalently.

Any of the reagents disclosed herein may be spotted using capillary tubes, pipets, ink-jet printing, or the like. In a mass-production setting, pins, such as used in microarrays, may be used to deposit the reagents. The spotted reagents may be allowed to air dry at room temperature (e.g., for at least 30 minutes) or may be dried under a vacuum, before using an apparatus 10.

In a preferred embodiment, and as by way of example, an apparatus 10 may be configured in a following manner. A plurality of hydrophilic, porous media (e.g., cloth, nitrocellulose, and paper) is utilized, the configuration of which provides varying porosity and functionality. A hydrophilic, porous media is patterned either physically (e.g., cutting with a CO₂ laser) or with hydrophobic barriers. A casing 12 is used to align regions of hydrophilic, porous media within an apparatus 10 and ensure contact is maintained between flow layers 18.

A casing 12 is further provided with apertures, where at least one aperture is aligned with a sample addition port 14 and at least another one aperture is aligned with a detection region 16 to facilitate introduction of a sample and to enable observance of a detection signal 38. A sample (approximately 30-150 μL) is added to a sample addition port 14, contacting a layer of cut cloth containing preprocessing reagents (e.g., immobilized glucose oxidase and immobilized catalase), thereby removing contaminant from a sample. A sample then wicks vertically to a layer of cut nitrocellulose, where it encounters a responsive reagent 36 (e.g., anti-rabbit IgG labeled with glucose oxidase) that binds to a target analyte (e.g., rabbit IgG).

A sample is then split into two channels (assay channel 20 and control channel 22) as it wicks laterally. In both channels 20, 22, a sample reaches a region containing additional responsive reagent 36 (e.g., an immobilized antibody). In an assay channel 20, the immobilized antibody (e.g., anti-rabbit IgG) binds the analyte-antibody-glucose oxidase complex, removing glucose oxidase from a sample solution. In a control channel 22, the immobilized antibody (e.g., anti-mouse IgG) does not bind the analyte-antibody-glucose oxidase complex. A sample continues to wick laterally before encountering another responsive reagent 36 (e.g., glucose). The glucose oxidase complex in solution reacts with glucose to generate hydrogen peroxide in solution.

A sample then wicks vertically through a plurality of layers of paper patterned with hydrophobic barriers. A sample encounters a layer containing a detection reagent 32, which responds to the presence of hydrogen peroxide. Following the detection reagent layer, a sample redissolves a dye, becoming brightly colored. A dye in an assay channel 20 is a distinctly different color than a dye in a control channel 22 (e.g., assay channel 20 dye may be orange and control channel 22 dye may be blue). The next layer laterally directs a sample from both an assay channel 20 and control channel 22 towards a detection region 16. A sample-portion that reaches a detection region 16 first, saturates that detection region 16 with color, preventing another sample-portion from coloring that detection region 16. The color observed in a detection region 16 correlates to the presence of a target analyte within a sample.

In some embodiments, a detection region 16 is offset towards an assay channel 20 to minimize false negatives. The rate at which a sample wicks through a detection reagent and reaches a detection region 16 is dependent on a concentration of hydrogen peroxide generated. If a target analyte is present, or above a minimum concentration, an assay channel 20 will have less glucose oxidase complex, compared to a control channel 22, to react with glucose, decreasing an amount of hydrogen peroxide generated. When a target analyte is present, a control channel 22 will generate more hydrogen peroxide, reaching a detection region 16 first, causing a detection region 16 to turn blue (i.e., positive for a target analyte).

If a target analyte is not present, or below a minimum concentration, an assay channel 20 will have a same amount of glucose oxidase complex to react with glucose as does a control channel 22. When a target analyte is absent, a control channel 20 and an assay channel 22 will generate a same amount of hydrogen peroxide, but a sample-portion in an assay channel 20 will encounter a detection region 16 first due to an offset, causing that detection region 16 to turn orange (i.e., negative for a target analyte).

In a preferred embodiment providing semi-quantitative detection, and as by way of example, an apparatus 10 may be configured in a following manner. A plurality of hydrophilic, porous media (e.g., cloth, nitrocellulose, and paper) is utilized, the configuration of which provides varying porosity and functionality. A hydrophilic, porous media is patterned either physically (e.g., cutting with a CO₂ laser) or with hydrophobic barriers. A casing 12 is used to align regions of hydrophilic, porous media within an apparatus 10 and ensure contact is maintained between flow layers 18.

A casing 12 is further provided with apertures, where at least one aperture is aligned with a sample addition port 14 and at least another one aperture is aligned with a detection region 16 to facilitate introduction of a sample and to enable observance of a detection signal 38. A sample (approximately 30-150 μL) is added to a sample addition port 14, contacting a layer of cut cloth containing preprocessing reagents (e.g., immobilized glucose oxidase and immobilized catalase), thereby removing contaminant from a sample. A sample then wicks vertically to a layer of cut nitrocellulose, where it encounters a responsive reagent 36 (e.g., anti-rabbit IgG labeled with glucose oxidase) that binds to a target analyte (e.g., rabbit IgG).

A sample is then split into two channels (assay channel 20 and control channel 22) as it wicks laterally. In both channels 20, 22, a sample reaches a region containing additional responsive reagent 36 (e.g., an immobilized antibody). In an assay channel 20, the immobilized antibody (e.g., anti-rabbit IgG) binds the analyte-antibody-glucose oxidase complex, removing glucose oxidase from a sample solution. In a control channel 22, the immobilized antibody (e.g., anti-mouse IgG) does not bind the analyte-antibody-glucose oxidase complex. A sample continues to wick laterally before encountering another responsive reagent 36 (e.g., glucose). The glucose oxidase complex in solution reacts with glucose to generate hydrogen peroxide in solution.

A sample then wicks vertically through a plurality of layers of paper patterned with hydrophobic barriers. A sample encounters a layer containing a detection reagent 32, which responds to the presence of hydrogen peroxide. Following the detection reagent layer, a sample redissolves a dye and salt, becoming brightly colored. A dye in an assay channel 20 is a distinctly different color than a dye in a control channel 22, and they incorporate an appropriate salt pair (e.g., assay channel 20 dye may be orange with sodium tetraphenylborate and control channel 22 dye may be blue with potassium carbonate). The next layer laterally directs a sample from both an assay channel 20 and control channel 22 toward one another within a detection region 16. Because the assay channel 20 and control channel 22 contain at least one coloring agent 52 of contrasting color (e.g., blue dye and orange dye), the concentration of an analyte may be approximated by the lateral position of convergence of the colored sample-portions within the detection region 16. Due to the formation of insoluble salts upon convergence of the sample-portions that may prevent mixing of colored dyes, this determination may be made immediately upon convergence or at a later time.

The rate at which a sample-portion wicks through a detection reagent 32 and the location at which it converges with other sample-portions is dependent on a concentration of hydrogen peroxide generated. If a target analyte is present above a minimum concentration, an assay channel 20 will have less glucose oxidase complex, compared to a control channel 22, to react with glucose, decreasing an amount of hydrogen peroxide generated. When a target analyte is present, a control channel 22 will generate more hydrogen peroxide, causing the sample-portion containing the blue dye to advance farther than the sample-portion containing the orange dye before the sample-portions converge. Higher analyte concentrations will result in the blue dye advancing even farther as compared to lower analyte concentrations.

If a target analyte is not present, an assay channel 20 will have a same amount of glucose oxidase complex to react with glucose as does a control channel 22. When a target analyte is absent, a control channel 22 and an assay channel 20 will generate a same amount of hydrogen peroxide, causing the sample-portions containing the contrasting dye colors to travel an equivalent distance prior to convergence.

In a preferred embodiment providing quantitative detection, and as by way of example, an apparatus 10 may be configured in a following manner. A plurality of hydrophilic, porous media (e.g., cloth, nitrocellulose, and paper) is utilized, the configuration of which provides varying porosity and functionality. A hydrophilic, porous media is patterned either physically (e.g., cutting with a CO₂ laser) or with hydrophobic barriers. A casing 12 is used to align regions of hydrophilic, porous media within an apparatus 10 and ensure contact is maintained between flow layers 18.

A casing 12 is further provided with apertures, where at least one aperture is aligned with a sample addition port 14 and at least another one aperture is aligned with a detection region 16 to facilitate introduction of a sample and to enable observance of a detection signal 38. A sample (approximately 30-150 μL) is added to a sample addition port 14, contacting a layer of cut cloth containing preprocessing reagents (e.g., immobilized glucose oxidase and immobilized catalase), thereby removing contaminant from a sample. A sample then wicks vertically to a layer of cut nitrocellulose, where it encounters a responsive reagent 36 (e.g., anti-rabbit IgG labeled with glucose oxidase) that binds to a target analyte (e.g., rabbit IgG).

A sample is then split into two channels (assay channel 20 and control channel 22) as it wicks laterally. In both channels 20, 22, a sample reaches a region containing additional responsive reagent 36 (e.g., an immobilized antibody). In an assay channel 20, the immobilized antibody (e.g., anti-rabbit IgG) binds the analyte-antibody-glucose oxidase complex, removing glucose oxidase from a sample solution. In a control channel 22, the immobilized antibody (e.g., anti-mouse IgG) does not bind the analyte-antibody-glucose oxidase complex. A sample continues to wick laterally before encountering another responsive reagent 36 (e.g., glucose). The glucose oxidase complex in solution reacts with glucose to generate hydrogen peroxide in solution.

A sample then wicks vertically through a plurality of layers of paper patterned with hydrophobic barriers. A sample encounters a layer containing a detection reagent 32, which responds to the presence of hydrogen peroxide. Following a detection reagent layer, a sample encounters conductive salts, thereby becoming conductive. As a conductive sample within a first channel encounters an electrode 56 (e.g., copper tape), a first circuit is closed. Upon closing a first circuit, an external reader (e.g., cellular phone) begins measuring time, stopping measurement when a conductive sample within a second channel closes a second circuit. The measure difference in time corresponds to a concentration of a target analyte within a sample. When a target analyte is present, less glucose oxidase reacts within an assay channel 20, causing less hydrogen peroxide to be generated, which causes a sample within that assay channel 20 to wick past a detection reagent 32 more slowly than does a sample within a control channel 22.

An electrode 56 within a control channel 22, therefore, is energized before an electrode 56 within an assay channel 20, which causes a closing of a circuit to which it is in electrical communication with to begin timing before the same occurs in an assay channel 22 to stop the timing. With increasing concentrations of a target analyte, a difference in time between detection signals 38 generated by an assay channel 20 and a control channel 22 will increase. Use of an electronic reader enables a user to utilize an apparatus 10 without a need to manually measure and record detection signals from an apparatus 10, as such measuring and recording is performed electronically.

It is understood that improving functionality and sensitivity of the apparatus 10 may be achieved with various combinations and permutations of the several embodiments and alternatives described herein.

Detection Reagent Polymers

Embodiments of the invention may include as a detection reagent polymers and/or oligomers that depolymerize autonomously in response to specific signals. Suitable polymers are reported, for example, in U.S. Pat. No. 8,871,893, to Phillips, et al., which is incorporated by reference herein. Polymers that are capable of selectively responding to signals in a sample and providing an amplified response open new capabilities of diagnostic assays to detect analytes that are only present at trace levels in a sample. Traditional means for detection of trace level analytes rely on time-consuming methods and/or expensive laboratory equipment, in order to increase the analyte and/or signal to a level that can be easily quantified. Depolymerizable polymers that produce an amplified response are capable of providing rapid, sensitive assays that do not rely on expensive laboratory equipment to achieve quantification of trace level analytes.

One or more of the following documents may be useful in understanding one or more embodiments of the invention. Inclusion of a document herein is not an admission that it is prior art or that it adversely affects the patentability of any claim of this application. The documents are incorporated by reference as if rewritten herein. Where this specification differs from one or more of the cited documents, this specification controls. Documents of interest include Sagi et al., J Am Chem Soc 2008, 130, 2; Weinstain et al., Chemistry 2008, 14, 6857-6861; DeWit and Gillies, J Am Chem Soc 2009, 131, 8; Avital-Shmilovici and Shabat, Soft Matter 2010, 6, 1073; DeWit et al., J Polym Sci A Polym Chem 2010, 48, 9; Esser-Kahn et al., J Am Chem Soc 2010, 132, 3; Fomina et al., J Am Chem Soc 2010, 132, 3; Horgan et al., Trends Biotechnol 2010, 28, 485-494; DeWit and Gillies, Org Biomol Chem 2011, 9, 1846-1854; Esser-Kahn et al., Macromolecules 2011, 44, 5539-5553; Esser-Kahn et al., Adv Mater 2011, 23, 3654-3658; Chen et al., Macromolecules 2012, 45, 7364-7374; Lewis et al., Angew Chem Int Ed 2012, 51, 12707-12710; Schmid et al., J Org Chem 2012, 77, 4363-4374; Wong et al., Adv Drug Deliv Rev 2012, 64, 1031-1045; de Gracia Lux and Almutairi, ACS Macro Lett 2013, 2, 432-435; de Gracia Lux et al., Journal of Polymer Science Part A: Polymer Chemistry 2013, 51, 3783-3790; DiLauro et al., Macromolecules 2013, 46, 3309-3313; DiLauro et al., Macromolecules 2013, 46, 2963-2968; DiLauro et al., Macromolecules 2013, 46, 7257-7265; Lewis et al., Anal Chem 2013, 85, 10432-10439; Lewis et al., Macromolecules 2013, 46, 5177-5183; McBride and Gillies, Macromolecules 2013, 46, 5157-5166; Mejia and Gillies, Polymer Chemistry 2013, 4, 1969; Olah et al., Macromolecules 2013, 46, 5924-5928; Phillips and Lewis, MRS Bulletin 2013, 38, 315-319; Robbins et al., J Org Chem 2013, 78, 3159-3169; Fan et al., J Am Chem Soc 2014, 136, 10116-10123; Lewis et al., Chem Commun 2014, 50, 5352-5354; Phillips and DiLauro, ACS Macro Letters 2014, 3, 298-304; DiLauro et al., Angewandte Chemie International Edition 2015, n/a-n/a; DiLauro and Phillips, Polym. Chem. 2015; Lewis and Phillips, Methods Mol Biol 2015, 1256, 213-229; Yeung et al., J Am Chem Soc 2015, 137, 5324-5327.

It should be noted that throughout this disclosure, the terms “end-cap”, “trigger”, “detection unit”, and “triggering group” are used interchangeably and are separate from “capping group”.

Throughout this disclosure, the terms “polymer” and “oligomer” are used interchangeably, indicating polymers that contain 2 to 10,000 repeating units with a most preferred length of 1000 repeating units. Those skilled in the art will recognize that even longer polymers are possible using the methods taught herein. Compounds reported herein may also be present as monomers.

Linear Signal-Responsive Polymers and their Uses in Diagnostic Assays

Our polymers take advantage of a difference in stability between the end-capped polymer and the un-end-capped polymer. Our polymer can consist of a variety of polymer backbones that depolymerize upon removal of the end-cap group in response to a specific signal (rather than non-specific signals such as acid or base). The derivative of the inventive polymers can include poly(benzyl ethers) and derivatives thereof. Depolymerization of the polymer may occur upon contact with a sample in solution. A liquid solution may for example be, but is not limited to, water (distilled, deionized, buffered, ocean, stream, lake, and any natural source of water), biological fluids (including, but not limited to, tears, sputum, sweat, blood, plasma, serum, urine, and cerebrospinal fluid), and beverages (including, but not limited to, juices, milk, teas, sodas, coffee, wine, beer, and spirits). Polymers may also be used in devices as reported herein.

As we show herein, selectively responsive poly(benzyl ethers) are stable in the presence of acid, base, heat, or light. Removal of the end-cap group in basic conditions forms a phenoxide at the head of the polymer, which then undergoes an electron cascade along the backbone of the polymer to depolymerize completely from head to tail. Inclusion of an aromatic ring at the benzylic position significantly increases the rate of depolymerization, resulting in complete depolymerization within minutes to hours after exposure to the specific stimulus. The included aromatic ring can be modified with functional groups (e.g., pinacol boronic ester, referred to as “Bpin”) to provide a variety of added functionality to the polymer, including, but not limited to, responsive, and solubility properties. In one embodiment, the “head” of the polymer is capped with an end-cap group (i.e., pinacol boronic ester), resulting in complete depolymerization in response to a specific signal.

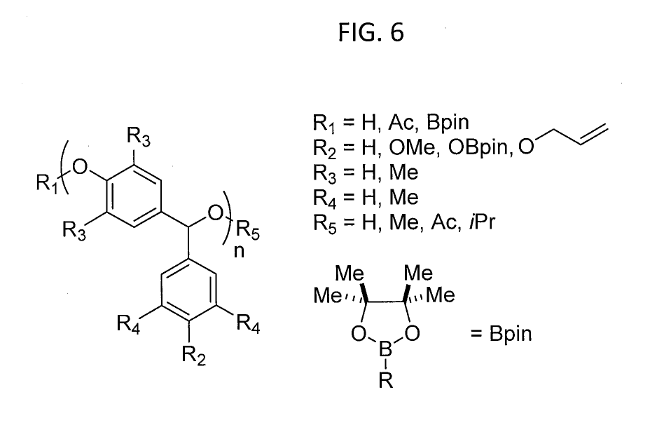

In another embodiment, the pendant aromatic ring of each repeating unit within the polymer is functionalized with a stimuli-responsive functional group, increasing the number of sites within the polymer at which depolymerization may be initiated. In yet another embodiment, polymers are made from a mixture of monomers with differently functionalized pendant phenyl rings or a mixture of monomers with functionalized and unfunctionalized pendant phenyl rings, to modulate the chemical and bulk properties of the polymer while maintaining the ability to initiate depolymerization from the pendant phenyl rings of some repeating units. The general scheme of a linear depolymerizable poly(benzyl ether) as reported herein is shown in FIG. 6.

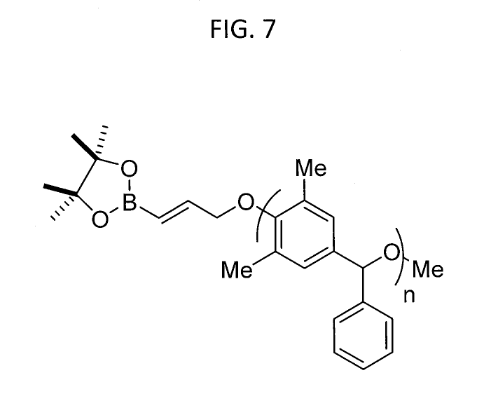

In one embodiment, a benzyl ether monomer was prepared after multistep synthesis. The monomer was polymerized through an anionic polymerization initiated by an alcohol (e.g., methanol), and a base catalyst, including, but not limited to, P₁-t-Bu base and P₂-t-Bu base. After a time of at least 3 hours, the growing polymer chain was end-capped via the addition of an electrophilic reagent, including, but not limited allyl vinyl boronic ester (responsive to hydrogen peroxide). The polymer was isolated as a white solid by precipitation by addition to cold methanol and filtration. The length of the polymer can be controlled by the equivalents of initiator and base catalyst, as well as polymerization temperature. This example is shown in FIG. 7.

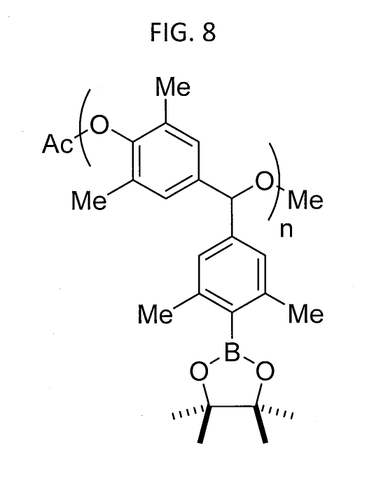

In a further example, a substituted benzyl ether monomer having a functional group on the pendant aromatic ring (i.e., Bpin), was prepared after multistep synthesis. The monomer was polymerized through an anionic polymerization initiated by an alcohol (e.g., methanol), and a base catalyst, including, but not limited to, P₁-t-Bu base and P₂-t-Bu base. After a time of at least 3 hours, the growing polymer chain was end-capped via the addition of an electrophilic reagent, including, but not to limited acetic anhydride. The polymer was isolated as a white solid by precipitation by addition to cold methanol and filtration. The length of the polymer can be controlled by the equivalents of initiator and base catalyst, as well as polymerization temperature. This example is shown in FIG. 8.

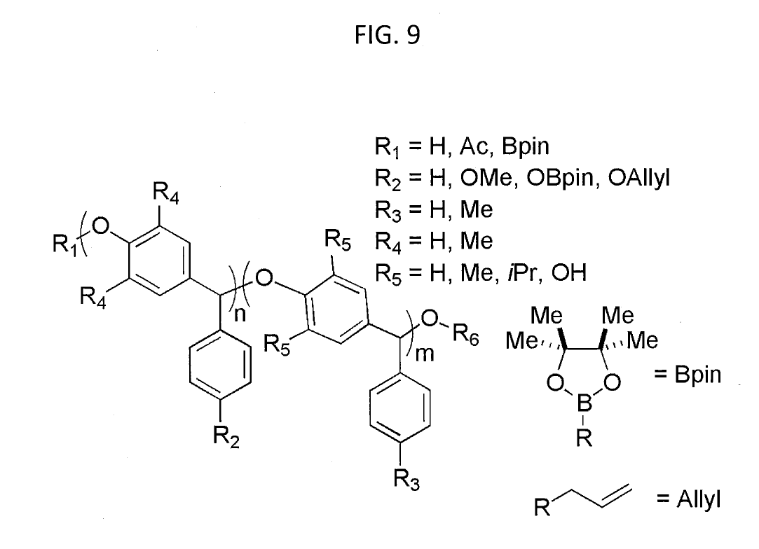

In further embodiments, two different benzyl ether monomers, one with a functional group on the pendant aromatic ring (i.e., Bpin), and one with no functional group on the pendant aromatic ring were prepared after multistep syntheses. The monomers were polymerized through an anionic polymerization initiated by an alcohol (e.g., methanol), and a base catalyst, including, but not limited to, P₁-t-Bu base and P₂-t-Bu base. After a time of at least 3 hours, the growing polymer chain was end-capped via the addition of an electrophilic reagent, including, but not limited to acetic anhydride. The polymer was isolated as a white solid by precipitation by addition to cold methanol and filtration. The length of the polymer can be controlled by the equivalents of initiator and base catalyst, as well as polymerization temperature. This example is shown in FIG. 9.

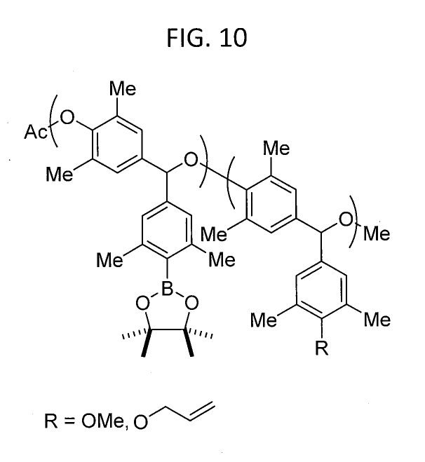

In further embodiments, two different benzyl ether monomers, with two different functional groups on the pendant aromatic ring (i.e., Bpin and allyl ether or OMe), were prepared after multistep syntheses. The monomers were polymerized through an anionic polymerization initiated by an alcohol (e.g., methanol), and a base catalyst, including, but not limited to, P₁-t-Bu base and P₂-t-Bu base. After a time of at least 3 hours, the growing polymer chain was end-capped via the addition of an electrophilic reagent, including, but not limited to acetic anhydride. The polymer was isolated as a white solid by precipitation by addition to cold methanol and filtration. The length of the polymer can be controlled by the equivalents of initiator and base catalyst, as well as polymerization temperature. This embodiment is shown in FIG. 10.

Although embodiments described herein have been described to this point as polymers, it will be understood by those skilled in the art that copolymers may be used. These may include for example but are not limited to block copolymers, statistical copolymers, periodic copolymers, and alternating copolymers.

Polymers used in the invention may be of any desirable length. When “n” is the length of the polymer in units, preferred polymers may have n between 2 to 10,000, n between 2 and 5000, n between 2 to 1000, n between 2 to 500, n between 2 to 400, n between 2 to 300, n between 2 to 200, n between 2 to 100, n between 2 to 50, and n between 2 and 10. In further embodiments the polymers have n between to 50 and 10,000, n between 50 and 5000, n between 50 and 1000, n between 50 and 500, n between 50 and 400, n between 50 and 300, n between 50 and 200, n between 50 and 100, and n between 20 and 50. In additional embodiments the polymers have n between to 100 and 10,000, n between 100 and 5000, n between 100 and 1000, n between 100 and 500, n between 100 and 400, n between 100 and 300, and n between 100 and 200. In even more embodiments the polymers have n between to 200 and 10,000, n between 200 and 5000, n between 100 and 1000, n between 200 and 500, n between 200 and 400, and n between 200 and 300. In yet still further embodiments n is at least 2, at least 10, at least 50, at least 100, at least 1000, or at least 10,000. In some embodiments “n” may be 1. These ranges may be applied to any of the uses of “n” in the disclosure presented here. As those of skill in the art will recognize, the ability to create long polymer chains is significant because such polymers may provide increased amplification for diagnostic assays.

Some embodiments may include polymeric portions with lengths designated by “m,” where “m” is a length of polymer units. Preferred polymers may have m between 2 to 10,000, m between 2 and 5000, m between 2 to 1000, m between 2 to 500, m between 2 to 400, m between 2 to 300, m between 2 to 200, m between 2 to 100, m between 2 to 50, and m between 2 and 10. In further embodiments the polymers have m between to 50 and 10,000, m between 50 and 5000, m between 50 and 1000, m between 50 and 500, m between 50 and 400, m between 50 and 300, m between 50 and 200, m between 50 and 100, and m between 20 and 50. In additional embodiments the polymers have m between to 100 and 10,000, m between 100 and 5000, m between 100 and 1000, m between 100 and 500, m between 100 and 400, m between 100 and 300, and m between 100 and 200. In even more embodiments the polymers have m between to 200 and 10,000, m between 200 and 5000, m between 100 and 1000, m between 200 and 500, m between 200 and 400, and m between 200 and 300. In yet still further embodiments m is at least 2, at least 10, at least 50, at least 100, at least 1000, or at least 10,000. In some embodiments “rn” may be 1. These ranges may be applied to any of the uses of “m” in the disclosure presented here. As those of skill in the art will recognize, the ability to create long polymer chains is significant because such polymers may provide increased amplification for diagnostic assays.

II. Cyclic Responsive Polymers and their Uses in Diagnostic Assays

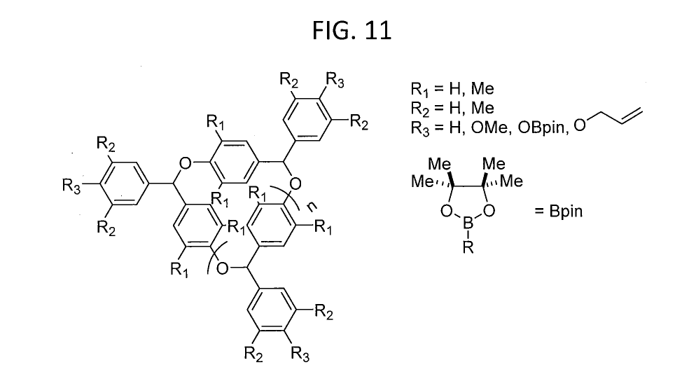

As we show herein, cyclic selectively responsive poly(benzyl ethers) are stable in the presence of acid, base, heat, or light. The cyclic polymers can include, but are not limited to, 2, 3, 4, or 5 repeating units. The pendant aromatic ring in each repeating unit of the cyclic polymer can be functionalized with a functional group (i.e., an end-cap group). Removal of an end-cap group in basic conditions forms a phenoxide, which then undergoes an electron cascade through the backbone of the polymer to depolymerize completely. In one embodiment, each repeating unit is functionalized with a single end-cap group (i.e., Bpin), such that each group is capable of initiating depolymerization. A genus including cyclic poly(benzyl ethers) is shown in FIG. 11, wherein n may be 2-5. In other embodiments n may be 2-10, 10-15, or 10-20.

In yet another embodiment, polymers are made from a mixture of monomers with differently functionalized pendant phenyl rings or a mixture of monomers with functionalized and unfunctionalized pendant phenyl rings, to modulate the chemical and bulk properties of the polymer while maintaining the ability to initiate depolymerization from the pendant phenyl rings of some, or all, repeating units.

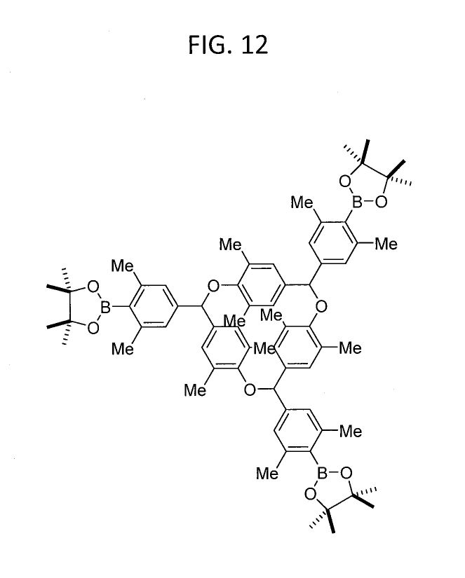

In a preferred embodiment, a substituted benzyl ether monomer having a functional group on the pendant aromatic ring (i.e., Bpin), was prepared after multistep synthesis. The monomer was polymerized through a cationic polymerization, initiated with an acid catalyst (i.e., boron trifluoride diethyl etherate). After a time of at least 12 hours, the polymer was isolated as a white solid by precipitation by addition to cold methanol and filtration. This example is shown in FIG. 12.

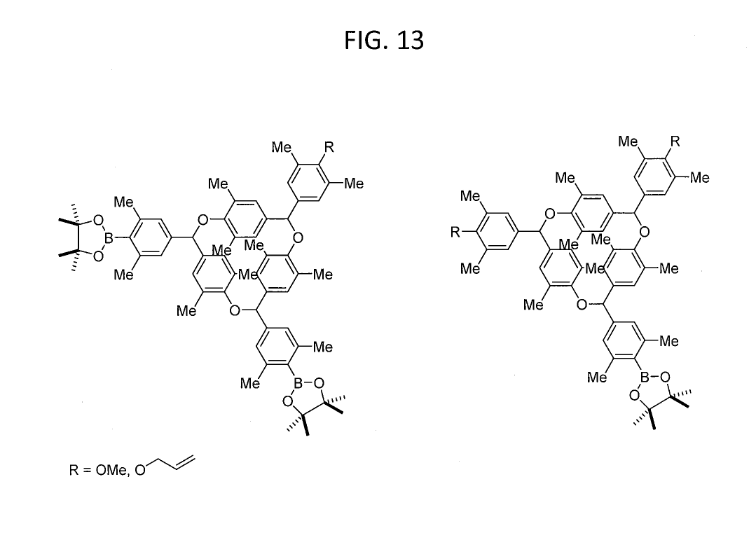

In another embodiment, two different benzyl ether monomers, with two different functional groups on the pendant aromatic ring (i.e., Bpin and allyl ether or OMe), were prepared after multistep syntheses. The monomers were polymerized through a cationic polymerization initiated with an acid catalyst (i.e., boron trifluoride diethyl etherate). After a time of at least 12 hours, the polymer was isolated as a white solid by precipitation by addition to cold methanol and filtration. These are shown in FIG. 13.

III. End Groups

Each polymer as reported above includes a triggering group that defines the stimulus that will initiate depolymerization. Selection of these triggering groups may be governed, for example, by factors including but not limited to the desired physical or chemical signal for depolymerization. Examples of triggering groups are listed below. For each triggering group the signal that will be recognized by the triggering group and lead to depolymerization is included in parentheses following the triggering group. They may include, for example, but not limited to aryl or vinyl boronate esters (hydrogen peroxide), and aryl or vinyl boronic acid (hydrogen peroxide). Boronic esters can be formed from the condensation of a boronic acid with a diol, which can include, but is not limited to, pinacol, trimethylene glycol, isopropanol, cyclohexanediol, catechol, glucose, and ethylene glycol.

The diol used in the triggering group may not change the selectivity of the assay, but may still give beneficial effects to the overall polymer. For example, certain diols may be selected to (i) increase the yields of the polymerization reaction; (ii) increase the rate of the polymerization reaction; (iii) increase the length of the polymer; (iv) increase or decrease the polydispersity of the polymer; (v) increase the stability of the polymer to minimize non-specific depolymerization; (vi) serve as a chemical handle for attaching the polymer to surfaces or other reagents; and (vii) continue the depolymerization process of neighboring polymers by releasing a reagent that cleaves the trigger of neighboring polymers.

Some polymers as reported herein may include a linker between the polymer and the end-cap. Inclusion of a linker may have a number of beneficial effects, including allowing an artisan to incorporate a variety of end-caps during the polymerization reaction.

Polymers as reported herein may be useful in the apparatus reported herein. This may be illustrated, for example, by use in both single-channel and dual-channel devices for assay of creatine kinase, which were prepared and tested as reported below.

Materials

All reactions were performed in flame-dried glassware under a positive pressure of argon unless otherwise noted. Air- and moisture-sensitive liquids were transferred via syringe or stainless steel cannula. Organic solutions were concentrated by rotary evaporation (25-40 mmHg) at 30° C. All reagents were purchased commercially and were used as received unless otherwise noted. All antibodies were purchased from AbCam Inc., and creatine kinase MB protein (30-AC67) was purchased from Fitzgerald Industries International. Dry pyridine was distilled over CaH₂ at 760 mmHg. Dry isopropanol was distilled over CaH₂ at 760 mmHg and stored over 3 Å molecular sieves. Acetonitrile, benzene, dichloromethane, N,N-dimethylformamide, dimethylsulfoxide, tetrahydrofuran, toluene, and triethylamine were purified by the method of Pangborn et al. Flash-column chromatography was performed as described by Still et al., employing silica gel (60-Å pore size, 32-63 μm, standard grade, Dynamic Adsorbents). Thin-layer chromatography was carried out on Dynamic Adsorbents silica gel TLC (20×20 cm w/h, F-254, 250 μm). Deionized water was purified with a Millipore purification system (Barnstead EASYpure® II UV/UF). The papers used were Whatman Chromatography Paper Grade I and Boise Aspen 30 Printer Paper (92 brilliant, 30% postconsumer content), and the adhesive used was 3M™ Super 77™ Multipurpose Adhesive. The laminate used was Protac™ Ultra UV (8.0 mil) with a Drytac® JetMounter™ JM26 laminator.

Methods

Photographs were acquired using a Nikon digital camera (D40 and D3100), using a Nikon 18-55 mm f/3.5-5.6G AF-S DX Nikkor VR SLR camera lens. Wax patterned paper was printed using a Xerox Phaser 8560 wax printer. Nitrocellulose, absorbent pads, and conjugate pads were cut using an Epilog mini 24 CO₂ laser.

Proton nuclear magnetic resonance (¹H NMR) spectra and carbon nuclear magnetic resonance spectra (¹³C NMR) were recorded using either a Bruker DPX-300 (300 MHz) NMR spectrometer, a Bruker AMX-360 (360 MHz), or a Bruker DRX-400 (400 MHz) NMR spectrometer at 25° C. Proton chemical shifts are expressed in parts per million (ppm) and are referenced to residual protium in the NMR solvent (CHCl₃ δ 7.26 ppm, CO(CH₃)₂ δ 2.05 ppm or SO(CH₃)₂ δ 2.50 ppm). Data are represented as follows: chemical shift, multiplicity (s=singlet, bs=broad singlet, d=doublet, dd=doublet of doublets, t=triplet, m=multiplet and/or multiple resonances), integration, and coupling constant (J) in Hertz. Carbon chemical shifts are expressed in parts per million and are referenced to the carbon resonances of the NMR solvent (CHCl₃ δ 77.0 ppm or CO(CH₃)₂ δ 29.8 and 206.3 ppm).

UV/vis spectroscopic data was obtained using a Beckman Coulter DU 800 spectrometer. LCMS data was obtained using an Agilent Technologies 1200 Series HPLC with a UV detector, a 6120 Series quadrupole mass spectrometer equipped with an atmospheric-pressure chemical ionization chamber, and a Thermo Scientific 150 mm×2.1 mm Betasil diphenyl column. Low resolution and high resolution mass spectra were acquired using mobile phases containing 5 mM ammonium formate.

GPC analyses were performed using an Agilent Technologies 1200 GPC equipped with a refractive index detector, a Malvern Viscotek model 270 Dual Detector with right and low-angle lighscattering, and a Viscotek T-column (300 mm×7.8 mm, CLM3012) and Agilent Resipore column (300 mm×7.5 mm) in series using DMF as the mobile phase (flow rate=1 ml/min). The GPC was calibrated using monodisperse polystyrene standards from Malvern.

Synthesis of Cyclic Trimer

Preparation of Compound 2. Synthesis of a cyclic trimer for use with embodiments of the invention begins with the synthesis of compound 2. Triflic acid (50 mL) is added 4-carboxyphenylbornic acid (4.98 g, 30 mmol, 1 equiv) is mixed with 2,6-dimethylphenol (3.67 g, 30 mmol, 1 equiv) and stirred at 100° C. for 3 hours. After allowing to cool to room temperature, the reaction is then diluted with water (100 mL) and quenched by the slow addition of NaHCO₃. The heterogeneous solution is diluted with EtOAc and extracted. The aqueous layer was extracted twice more and the organic layers combined, washed with brine, dried with MgSO₄, filtered, concentrated, resulting in compound 8 as an off-white solid (95%). Compound 8 was used without further purification. ¹H-NMR (360 MHz, CDCl₃): δ 7.90 (d, 2H, J=7.7), 7.70 (d, 2H, J=7.5), 7.50 (s, 2H), 5.08 (s, 1H, OH), 2.27 (s, 6H).

Pinacol (3.56 g, 30.1 mmol, 1 equiv) was added to the crude 8 and a THF-PhMe (1:1) solution was added until all material dissolved. The solution was then concentrated to a solid by rotary evaporation under vacuum. This process was repeated five times to yield 9 as an off white solid (100%). ¹H-NMR (360 MHz, CDCl₃): δ 7.90 (d, 2H, J=7.7), 7.70 (d, 2H, J=7.5), 7.50 (s, 2H), 5.08 (s, 1H, OH), 2.27 (s, 6H), 1.36 (s, 12H).

To compound 9, triethylsilane (15 mL, 93.9 mmol, 3.13 equiv) and trifluoroacetic acid (15 mL, 196 mmol, 6.53 equiv) was added and heated at 45° C. under argon. After the TLC indicated complete conversion (10-12 h), the reaction was quenched with NaHCO₃ and diluted with EtOAc. The organic layer was separated and the aqueous layer extracted with EtOAc×3. The combined organic layers were then washed with brine×3, dried with MgSO₄, filtered and concentrated to an orange solid. Compound 10 was recrystallized with hot hexanes as white needles or clear cubes (74%). ¹H-NMR (400 MHz, CDCl₃):): δ 7.73 (d, 2H, J=8), 7.20 (d, 2H, J=8), 6.78 (s, 2H), 4.48 (s, 1H, OH), 3.86 (s, 2H), 2.20 (s, 6H), 1.34 (s, 12H).

Silver(I) oxide (2.86 g, 12.4 mmol, 2.1 equiv) was added to a solution of compound 10 (2 g, 5.9 mmol, 1 equiv) in DCM (59 mL, 0.1 M) and stirred 12 h in the dark open to air through a needle. After TLC indicated completed conversion (14-18 h), the solution was diluted with an equal volume of hexanes and filtered over celite. The solution was concentrated and dried on hi-vac to yield bright canary yellow compound 2 which was used without further purification (98%). ¹H-NMR (400 MHz, CDCl₃):): δ 7.88 (d, 2H, J=8), 7.49 (s, 1H), 7.45 (d, 2H, J=8), 7.18 (s, 1H), 7.06 (s, 1H), 2.07 (s, 3H), 2.05 (s, 3H), 1.36 (s, 12H).

Synthetic Scheme for Compound 2

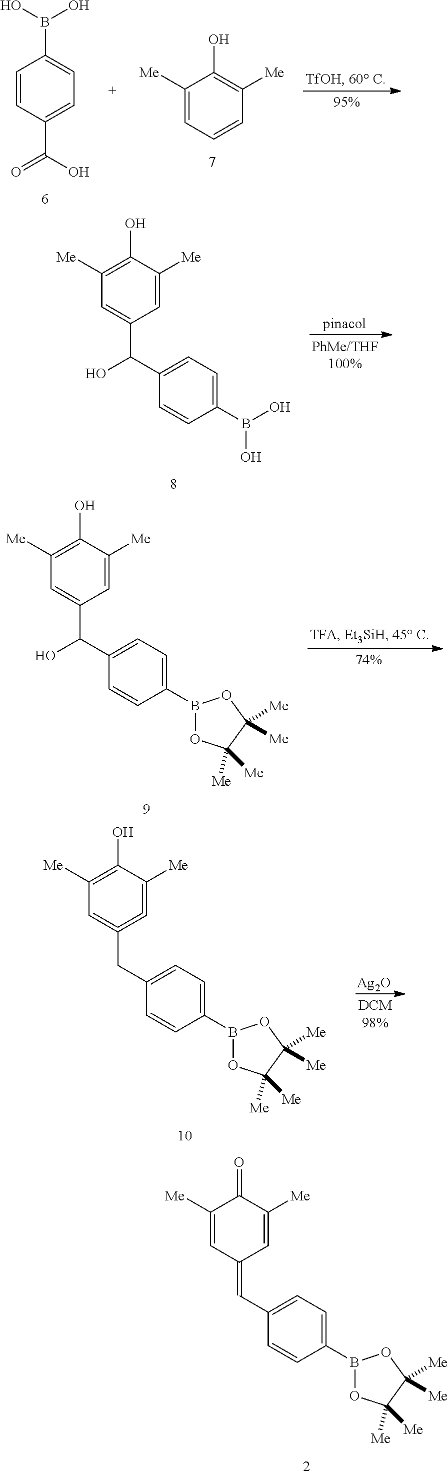

Preparation of Oligomer 1. Compound 2 (500 mg, 1.49 mmol, 1 equiv) was dissolved in DCM (1.5 mL, 1 M) under argon and boron trifluoride diethyl etherate (18 μL, 0.14 mmol, 0.1 equiv) was added in one portion at room temperature. The solution immediately turned red and after 10 minutes a white precipitate could be seen. The solution was allowed to react for 5 h, the white precipitate was washed with methanol, collected in a fritted funnel, and washed three more times with methanol to yield oligomer 1 (83%). ¹H-NMR (400 MHz, CD₂Cl₂):): δ 7.79 (d, 2H, J=8), 7.55 (d, 2H, J=8), 6.86 (s, 1H), 6.46 (s, 1H), 2.12 (s, 3H), 1.46 (s, 3H), 1.34 (s, 12H). MS (TOF MS APCI+, m/z): 506.4 (100, M*2+H⁺); HRMS (MALDI-TOF MS, m/z) Calculated for C₆₃H₇₅B₃O₉ (M+Na⁺): 1031.7. Found: 1031.628.

### Synthetic Scheme for Oligomer 1

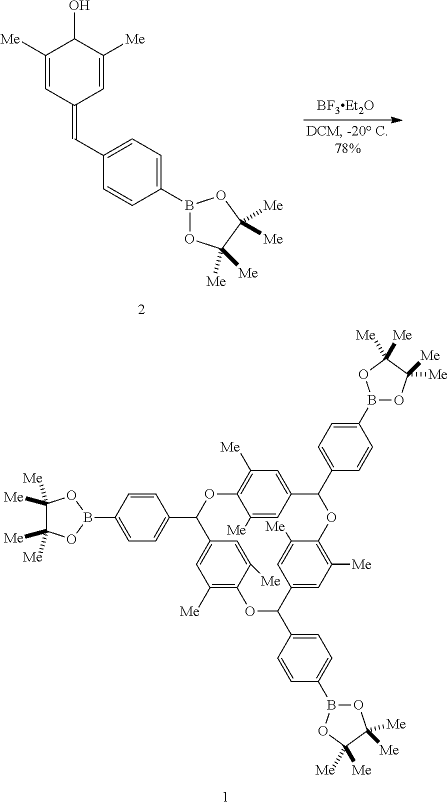

Those of skill in the art will note that the above-reported synthesis may also be useful for preparation of other embodiments as reported herein. Further guidance may be found, for example, in Yeung et al., J Am Chem Soc 2015, 137, 5324-5327 and Olah et al., Macromolecules 2013, 46, 5924-5928, both of which are incorporated by reference herein.

Fabrication of Devices:

Patterning Paper

Paper was patterned, and the wax was re-flown by placing the patterned paper in an oven at 150° C. for 105 s. The nitrocellulose, conjugate pad, and absorbent pad layers were patterned in CleWin, transferred to Adobe Illustrator® program and then cut (printed) using an Epilog™ mini 24 laser cutter.

Vertical Channel Paper-Based Device

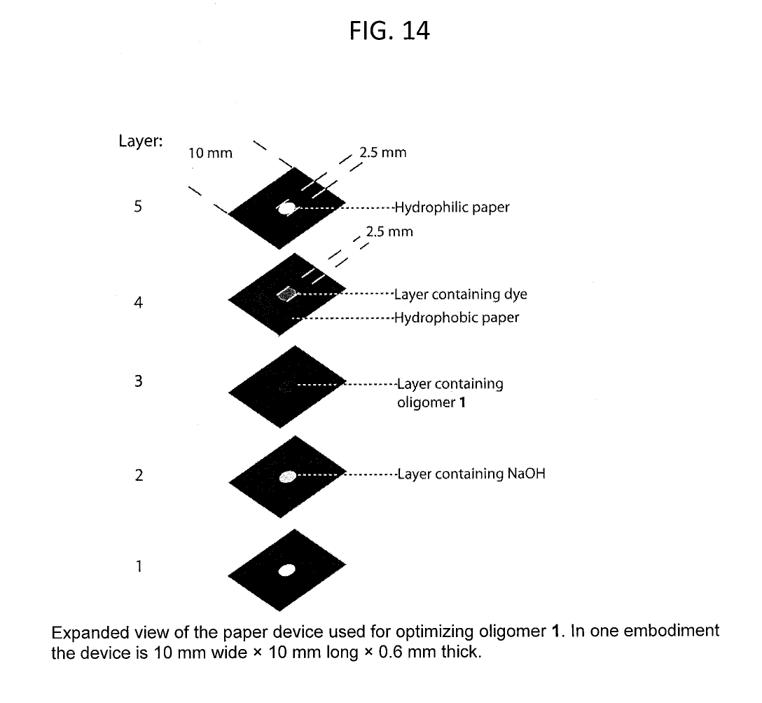

Paper-based devices were assembled as reported herein, using the layout shown in FIG. 14. Layer 3 was loaded with 0.25 μL of hydrophobic detection reagent 1 dissolved in CHCl₃. The solution of a hydrophobic detection reagent was spotted using a Drummond 0.25 μL disposable micropipet. Layer 2 was loaded with 2 μL of a 1 M NaOH solution.

Optimization of Cyclic Trimer 1

Single channel flow-through devices were used to optimize the quantity of compound 1, a cyclic trimer.

Procedure for Measuring Flow-Through.

We measured the time required for a sample to flow through the device in FIG. 14 as follows: to layer 1 was added 14 μL of an aqueous solution of H₂O₂. A timer was started immediately upon addition of the sample to the device. The device was turned over so that layer 5 was visible. The flow-through time was recorded when the hydrophilic region of layer 5 had completely changed color. Sixteen replicate tests were performed for each concentration of H₂O₂ and the two highest and two lowest flow-through times were removed from the data set to account for errors arising from failures during the device fabrication procedure.

TABLE 1
Flow-through times for single channel devices (FIG. 14) depositing
0.25 μL of compound # (9.4 mg/mL) in CHCl₃.

| | [H₂O₂] (μM) | | | | | |
|---|---|---|---|---|---|---|
| | 0 | 0.0001 | 0.0002 | 0.0005 | 0.001 | 0.002 |
| Flow- | 937 | 895 | 808 | — | 799 | 752 |
| Through | 979 | 951 | 834 | 809 | 739 | 770 |
| Time (s) | 985 | 954 | 868 | 832 | 696 | 781 |
| | 987 | 961 | 872 | 852 | 731 | 808 |
| | 998 | 970 | 893 | 891 | 894 | 825 |
| | 1042 | 973 | 927 | 909 | 870 | 831 |
| | 1057 | 975 | 940 | 916 | 803 | 885 |
| | 1057 | 982 | 954 | 922 | 881 | 906 |
| | 1061 | 988 | 967 | 943 | 926 | 920 |
| | 1066 | 996 | 978 | 969 | 857 | 922 |
| | 1075 | 1008 | 984 | 997 | 777 | 971 |
| | 1088 | 1011 | 1004 | 1021 | 802 | 978 |
| | 1112 | 1033 | 1014 | 1024 | 843 | 991 |
| | 1144 | 1041 | 1015 | 1044 | 841 | 1103 |
| | 1181 | 1075 | 1020 | 1205 | 928 | 1125 |
| | 1245 | 1133 | 1034 | 1460 | 836 | 1131 |
| Average | 1056.0 | 991.0 | 951.3 | 943.3 | 826.8 | 910.1 |
| Standard | 48.4 | 27.6 | 52.4 | 68.8 | 67.7 | 92.2 |
| Deviation | | | | | | |

TABLE 2
Flow-through times for single channel devices (FIG. 14)
depositing 0.25 μL of compound 1 (9.5 mg/mL) in CHCl₃.

[H₂O₂] (μM)

| | 0 | 0.1 | 0.2 | 0.5 | 1 |
|---|---|---|---|---|---|
| Flow- | 781 | 843 | 807 | 731 | 655 |
| Through | 1089 | 855 | 810 | 832 | 694 |
| Time (s) | 1120 | 868 | 812 | 855 | 709 |
| | 1130 | 904 | 813 | 880 | 821 |
| | 1149 | 908 | 818 | 853 | 829 |
| | 1155 | 912 | 819 | 760 | 846 |
| | 1159 | 918 | 821 | 891 | 847 |
| | 1171 | 921 | 826 | 859 | 850 |
| | 1212 | 945 | 832 | 780 | 853 |
| | 1217 | 955 | 858 | 758 | 858 |
| | 1220 | 961 | 884 | 817 | 875 |
| | 1222 | 968 | 907 | 803 | 877 |
| | 1242 | 971 | 927 | 869 | 910 |
| | 1245 | 975 | 938 | 740 | 944 |
| | 1246 | 1023 | 988 | 789 | 948 |
| | 1271 | 1053 | 1029 | 8347 | 986 |
| Average | 1186.8 | 933.8 | 854.6 | 822.1 | 851.6 |
| Standard | 44.2 | 33.5 | 47.1 | 52.7 | 56.4 |
| Deviation | | | | | |

TABLE 3
Flow-through times for single channel devices (FIG. 14)
depositing 0.25 μL of compound 1 (9.6 mg/mL) in CHCl₃.

| | [H₂O₂] (μM) | | | | | |
|---|---|---|---|---|---|---|
| | 0 | 0.1 | 0.2 | 0.5 | 1 | 2 |
| Flow- | 1213 | 1184 | 1021 | 840 | 725 | 666 |
| Through | 1219 | 1192 | 1066 | 927 | 733 | 677 |
| Time (s) | 1316 | 1193 | 1098 | 779 | 738 | 713 |
| | 1320 | 1242 | 1123 | 866 | 760 | 723 |
| | 1333 | 1244 | 1129 | 924 | 766 | 725 |
| | 1334 | 1244 | 1138 | 904 | 769 | 736 |
| | 1349 | 1290 | 1157 | 919 | 773 | 739 |
| | 1381 | 1304 | 1170 | 832 | 774 | 746 |
| | 1386 | 1338 | 1189 | 915 | 789 | 748 |
| | 1387 | 1339 | 1202 | 827 | 792 | 763 |
| | 1402 | 1347 | 1212 | 919 | 794 | 763 |
| | 1423 | 1374 | 1253 | 803 | 802 | 764 |
| | 1441 | 1389 | 1309 | 808 | 852 | 786 |
| | 1469 | 1424 | 1317 | 897 | 871 | 805 |
| | 1510 | 1472 | 1342 | 1001 | 885 | 885 |
| | 1522 | 1532 | 1370 | 1004 | 1044 | 892 |
| Average | 1378.4 | 1310.7 | 1191.4 | 866.1 | 790.0 | 750.9 |
| Standard | 49.6 | 69.9 | 71.2 | 53.4 | 37.8 | 26.8 |
| Deviation | | | | | | |

TABLE 4
Flow-through times for single channel devices (FIG. 14) depositing
0.25 μL of compound # (9.8 mg/mL) in CHCl₃.

| | [H₂O₂] (μM) | | | | |
|---|---|---|---|---|---|
| | 0 | 0.1 | 0.2 | 0.5 | 1 |
| Flow- | 1503 | 455 | 1020 | 874 | 920 |
| Through | 1508 | 1099 | 1047 | 933 | 927 |
| Time (s) | 1509 | 1157 | 1062 | 976 | 930 |
| | 1512 | 1224 | 1103 | 997 | 955 |
| | 1561 | 1282 | 1143 | 1009 | 963 |
| | 1561 | 1287 | 1155 | 1025 | 975 |
| | 1562 | 1296 | 1156 | 1032 | 977 |
| | 1576 | 1310 | 1177 | 1034 | 985 |
| | 1588 | 1319 | 1178 | 1042 | 986 |
| | 1597 | 1323 | 1183 | 1065 | 997 |
| | 1627 | 1328 | 1227 | 1076 | 1001 |
| | 1672 | 1329 | 1241 | 1084 | 1019 |
| | 1702 | 1331 | 1248 | 1090 | 1038 |
| | 1707 | 1347 | 1248 | 1110 | 1049 |
| | 1711 | 1403 | 1369 | 1120 | 1059 |
| | 1758 | 1614 | 1426 | 1173 | 1095 |
| Average | 1597.8 | 1294.4 | 1176.8 | 1045.0 | 989.6 |
| Standard | 66.7 | 54.1 | 58.4 | 40.7 | 34.1 |
| Deviation | | | | | |

TABLE 5
Flow-through times for single channel devices (FIG. 14)
depositing 0.25 μL of compound 1 (10.0 mg/mL) in CHCl₃.

| | [H₂O₂] (μM) | | | | | |
|---|---|---|---|---|---|---|
| | 0 | 0.1 | 0.5 | 1 | 2 | 5 |
| Flow- | 1518 | 1218 | 1290 | 1200 | 1086 | 1027 |
| Through | 1658 | 1483 | 1468 | 1233 | 1248 | 1131 |
| Time (s) | 2004 | 1742 | 1527 | 1292 | 1262 | 1148 |
| | 2027 | 1747 | 1538 | 1336 | 1269 | 1206 |
| | 2033 | 1786 | 1543 | 1359 | 1271 | 1230 |
| | 2165 | 1829 | 1610 | 1401 | 1314 | 1240 |
| | 2181 | 1848 | 1617 | 1428 | 1337 | 1257 |
| | 2198 | 1853 | 1633 | 1439 | 1346 | 1278 |
| | 2214 | 1868 | 1642 | 1443 | 1349 | 1343 |
| | 2257 | 1874 | 1659 | 1450 | 1357 | 1384 |
| | 2303 | 1912 | 1699 | 1527 | 1358 | 1384 |
| | 2311 | 1994 | 1700 | 1541 | 1395 | 1404 |
| | 2311 | 2004 | 1724 | 1553 | 1404 | 1418 |
| | 2312 | 2039 | 1787 | 1575 | 1420 | 1427 |
| | 2327 | 2097 | 1802 | 1577 | 1451 | 1480 |
| | 2700 | 2700 | 1811 | 1596 | 1769 | 1507 |
| Average | 2193.0 | 1874.7 | 1639.9 | 1445.3 | 1340.2 | 1309.9 |
| Standard | 116.2 | 97.4 | 79.9 | 90.2 | 52.9 | 94.6 |
| Deviation | | | | | | |

TABLE 6
Flow-through times for single channel devices (FIG. 14)
depositing 0.25 μL of compound 1 (10.5 mg/mL) in CHCl₃.

| | [H₂O₂] (μM) | | | | |
|---|---|---|---|---|---|
| | 0 | 0.1 | 0.5 | 1 | 2 |
| Flow- | 2331 | 2343 | 2293 | 2127 | 1893 |
| Through | 2334 | 2494 | 2299 | 2150 | 1969 |
| Time (s) | 2509 | 2507 | 2314 | 2167 | 1972 |
| | 2602 | 2528 | 2316 | 2173 | 1975 |
| | 2604 | 2537 | 2318 | 2200 | 1986 |
| | 2644 | 2549 | 2324 | 2213 | 2001 |
| | 2663 | 2566 | 2334 | 2261 | 2031 |
| | 2676 | 2567 | 2337 | 2272 | 2047 |
| | 2700 | 2569 | 2364 | 2290 | 2067 |
| | 2700 | 2588 | 2390 | 2353 | 2101 |
| | 2700 | 2642 | 2423 | 2369 | 2106 |
| | 2700 | 2656 | 2492 | 2371 | 2109 |
| | 2700 | 2659 | 2497 | 2381 | 2177 |
| | 2700 | 2700 | 2700 | 2399 | 2201 |
| | 2700 | 2700 | 2700 | 2423 | 2207 |
| | 2700 | 2700 | 2700 | 2469 | 2700 |
| Average | 2658.2 | 2589.0 | 2400.8 | 2287.4 | 2064.4 |
| Standard | 59.8 | 60.8 | 114.8 | 85.7 | 76.6 |
| Deviation | | | | | |

TABLE 7
Flow-through times for single channel devices (FIG. 14)
depositing 0.25 μL of compound 1 (10.6 mg/mL) in CHCl₃.

| | [H₂O₂] (μM) | | | | | | |
|---|---|---|---|---|---|---|---|
| | 0 | 0.1 | 0.5 | 1 | 2 | 5 | 10 |
| Flow- | 1670 | 1237 | 1127 | 1235 | 968 | 902 | 767 |
| Through | 1790 | 1382 | 1515 | 1236 | 969 | 927 | 771 |
| Time (s) | 1836 | 1899 | 1549 | 1240 | 991 | 938 | 792 |
| | 1869 | 1924 | 1553 | 1261 | 1016 | 947 | 798 |
| | 1912 | 1942 | 1569 | 1282 | 1038 | 951 | 800 |
| | 2008 | 1947 | 1574 | 1288 | 1079 | 957 | 820 |
| | 2014 | 1975 | 1587 | 1315 | 1108 | 958 | 855 |
| | 2038 | 1984 | 1591 | 1326 | 1143 | 971 | 859 |
| | 2067 | 2010 | 1599 | 1330 | 1150 | 986 | 871 |
| | 2092 | 2045 | 1599 | 1331 | 1150 | 1013 | 894 |
| | 2094 | 2071 | 1610 | 1332 | 1155 | 1019 | 902 |
| | 2116 | 2092 | 1638 | 1353 | 1170 | 1063 | 930 |
| | 2141 | 2095 | 1647 | 1384 | 1178 | 1115 | 968 |
| | 2147 | 2176 | 1688 | 1416 | 1213 | 1129 | 980 |
| | 2171 | 2184 | 1712 | 1420 | 1216 | 1155 | 981 |
| | 2271 | 2210 | 2211 | 1443 | 1221 | 1321 | 991 |
| Average | 2027.8 | 2013.3 | 1600.3 | 1321.5 | 1115.9 | 1003.9 | 872.4 |
| Standard | 104.9 | 83.4 | 40.7 | 49.7 | 70.0 | 66.0 | 64.6 |
| Deviation | | | | | | | |

Time-Based Quantification of Creatine Kinase

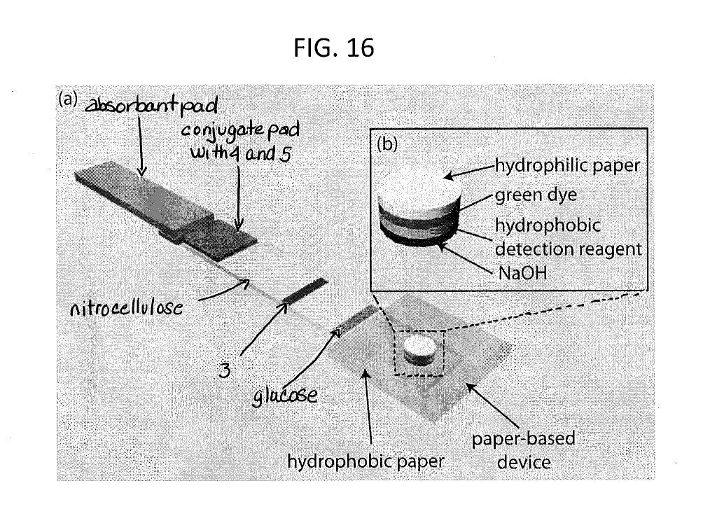

FIG. 16. shows a general layout of a lateral flow immunoassay combined with a paper-based device for the quantitative detection of creatine kinase (CK) by measuring time. The antibody complex comprising 4 and 5 is stored within the conjugate pad, along with buffer salts for controlling the pH of the sample. The lateral flow strip contains both 3 and glucose pre-deposited along the nitrocellulose. The antibodies used for detection of creatine kinase (CK) were: 3 (Mouse monoclonal to creatine kinase MB, ab19603), 4 (Goat polyclonal to creatine kinase MM, ab110655), and 5 (Rabbit anti-goat IgG H&L (glucose oxidase), ab136719).

The sample then reaches the paper-based device attached at the end of the lateral flow immunoassay, where it encounters the hydrophobic detection reagent, reacting as previously described. The amount of CK within the sample is quantified by measuring the time from addition of the sample to the appearance of color within the readout layer of the paper-based device. The dimensions of the paper portion of the device are 10 mm×10 mm×0.6 mm (l×w×h), while the dimensions of the lateral flow portion of the device are 50 mm×5 mm×1.0 mm (l×w×h).

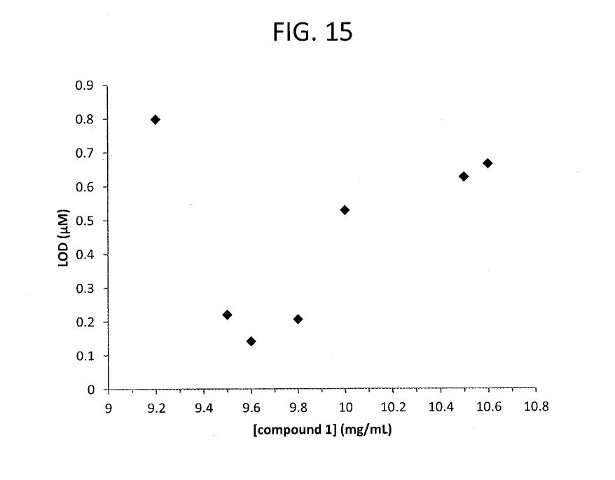

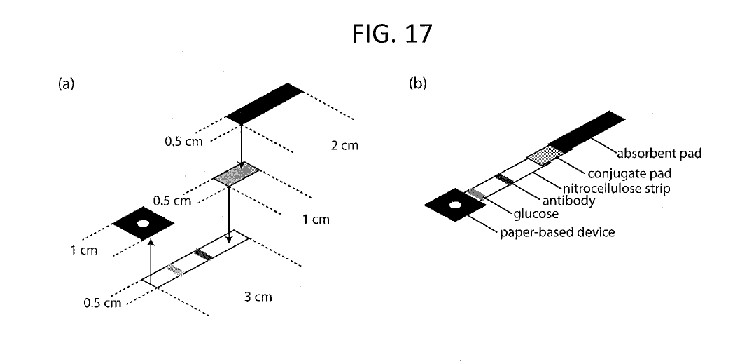

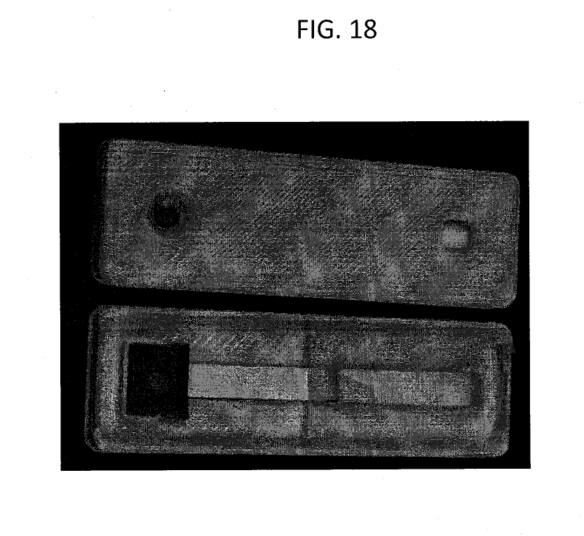

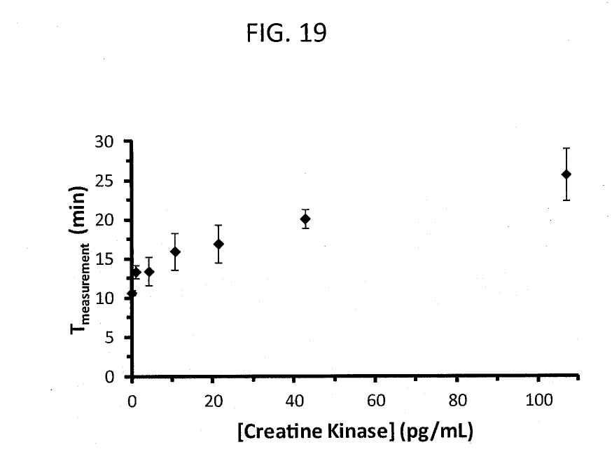

To the conjugate pad was added 30 μL of 4 (50 μg/mL) and 5 (1/200 dilution from stock) in 10 mM PBS buffer (pH 7.0) containing 0.7% BSA and 2.5% sucrose. The conjugate pad was then dried at 35° C. before being attached to the rest of the lateral flow test strip. To the nitrocellulose pad was added 2 μL of 3 (1 mg/mL) in 100 mM PBS buffer (pH 7.0) and 2 μL of 1 M glucose solution. The reagents were spotted on the nitrocellulose strip as indicated in Error! Reference source not found. The paper-based device used for the detection of CK was assembled as above, using the layout described in FIG. 14, and the optimized quantity of 1 shown in FIG. 15. The immunoassay device was assembled as shown in FIG. 17 loading into a 3-D printed plastic case (FIG. 18).

Assay for Creatine Kinase

To the sample addition port of the lateral flow immunoassay (shown in FIG. 18) was added 125 μL of sample. The time was measured from addition of the sample to the appearance of color in layer 5 of the paper-based device. The fastest and slowest flow-through times were omitted to account for error in device fabrication.

TABLE 8
Assay times for detecting creatine kinase in buffered water with a
lateral flow immunoassay device (FIG. 16). There were 6 replicates
for each concentration of creatine kinase. To account for errors in
fabricating the devices, the fastest and slowest assay times were not
used in determining the average or standard deviation values.

| | [H₂O₂] (μM) | | | | | | |
|---|---|---|---|---|---|---|---|
| | 0 | 0.1 | 0.5 | 1 | 2 | 5 | 10 |
| Flow- | 1670 | 1237 | 1127 | 1235 | 968 | 902 | 767 |
| Through | 1790 | 1382 | 1515 | 1236 | 969 | 927 | 771 |
| Time (s) | 1836 | 1899 | 1549 | 1240 | 991 | 938 | 792 |
| | 1869 | 1924 | 1553 | 1261 | 1016 | 947 | 798 |
| | 1912 | 1942 | 1569 | 1282 | 1038 | 951 | 800 |
| | 2008 | 1947 | 1574 | 1288 | 1079 | 957 | 820 |
| | 2014 | 1975 | 1587 | 1315 | 1108 | 958 | 855 |
| | 2038 | 1984 | 1591 | 1326 | 1143 | 971 | 859 |
| | 2067 | 2010 | 1599 | 1330 | 1150 | 986 | 871 |
| | 2092 | 2045 | 1599 | 1331 | 1150 | 1013 | 894 |
| | 2094 | 2071 | 1610 | 1332 | 1155 | 1019 | 902 |
| | 2116 | 2092 | 1638 | 1353 | 1170 | 1063 | 930 |
| | 2141 | 2095 | 1647 | 1384 | 1178 | 1115 | 968 |
| | 2147 | 2176 | 1688 | 1416 | 1213 | 1129 | 980 |
| | 2171 | 2184 | 1712 | 1420 | 1216 | 1155 | 981 |
| | 2271 | 2210 | 2211 | 1443 | 1221 | 1321 | 991 |
| Average | 2027.8 | 2013.3 | 1600.3 | 1321.5 | 1115.9 | 1003.9 | 872.4 |
| Standard | 104.9 | 83.4 | 40.7 | 49.7 | 70.0 | 66.0 | 64.6 |
| Deviation | | | | | | | |

Optimization of Antibodies for Immunoassay

Optimization of Antibody 1 (reagent 3)

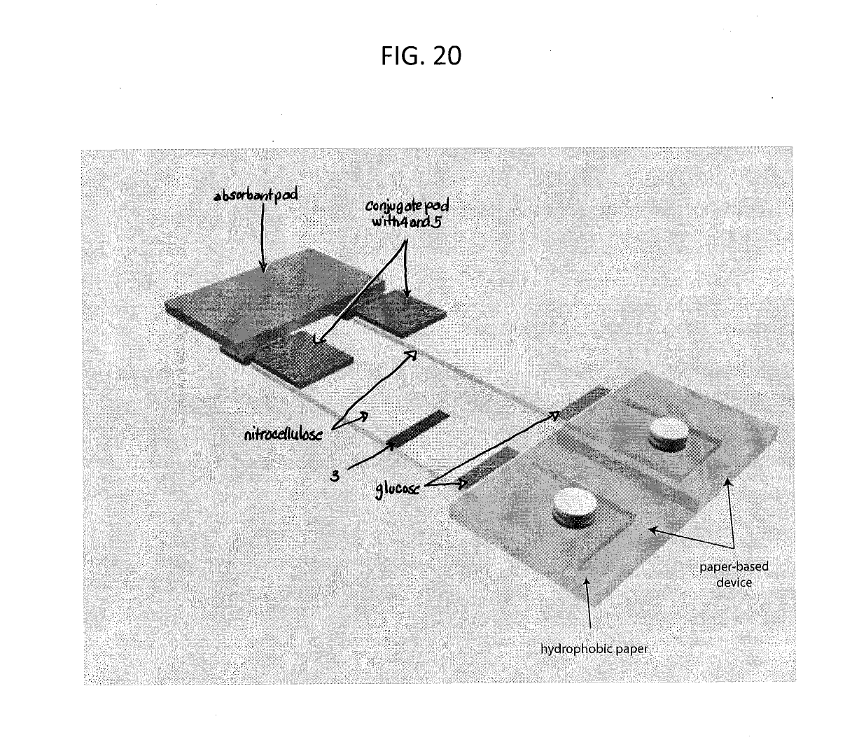

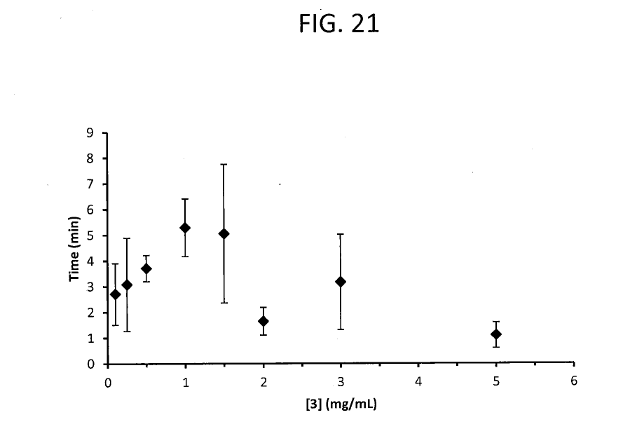

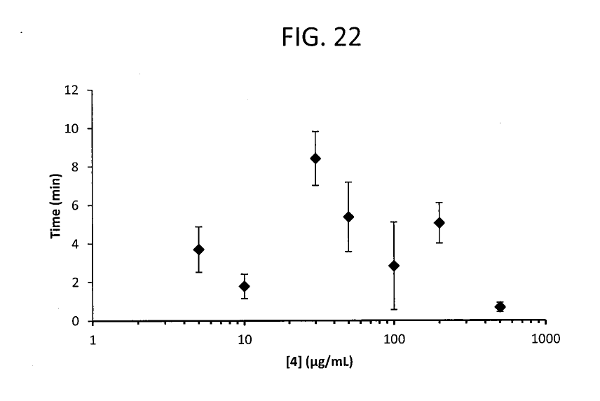

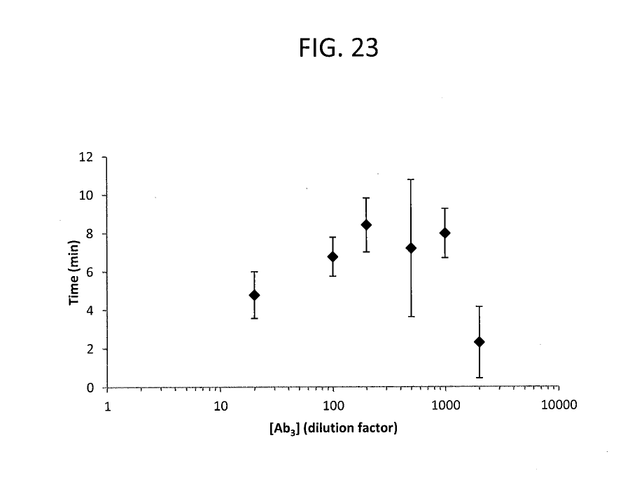

TABLE 9
Optimization of the concentration of 3 deposited on the nitrocellulose
of a dual-channel device as shown in FIG. 20. Each dual channel
device was challenged with 300 μL of 4.28 pg/mL CK in buffered
water. The time difference was measured as the concentration
of 3 was varied. There were 6 replicates for each concentration
of 3. To account for errors in fabricating the devices, the
fastest and slowest assay times were not used in determining
the average or standard deviation values.

| | [3] (mg/mL) | | | | | | | |
|---|---|---|---|---|---|---|---|---|
| | 0.1 | 0.25 | 0.5 | 1 | 1.5 | 2 | 3 | 5 |
| Flow- | 23 | 33 | 121 | 55 | 151 | 45 | — | — |
| through | 95 | 34 | 182 | 246 | 164 | 64 | 127 | 46 |
| time (s) | 106 | 194 | 221 | 281 | 192 | 84 | 168 | 49 |
| | 220 | 217 | 230 | 346 | 340 | 106 | 353 | 57 |
| | 229 | 293 | 256 | 397 | 516 | 140 | 112 | 110 |
| | 310 | — | 292 | 454 | 430 | 280 | 484 | 596 |
| Average | 162.5 | 184.5 | 222.3 | 317.5 | 303.0 | 98.5 | 190.0 | 65.5 |
| Standard | 71.8 | 108.9 | 30.7 | 67.3 | 161.6 | 32.6 | 111.2 | 30.0 |
| Deviation | | | | | | | | |

Optimization of Antibody 2

TABLE 10
Optimization of the concentration of 4 deposited on the nitrocellulose.
Each dual channel device was challenged with 300 μL of 4.28
pg/mL CK in buffered water. The time difference was measured as
the concentration of 4 was varied. There were 6 replicates for
each concentration of 4. To account for errors in fabricating the
devices, the fastest and slowest assay times were not used in determining
the average or standard deviation values.

| | [4] (mg/mL) | | | | | | |
|---|---|---|---|---|---|---|---|
| | 5 | 10 | 30 | 50 | 100 | 200 | 500 |
| Flow- | 33 | 1 | 284 | 44 | 33 | 42 | 1 |
| through | 152 | 69 | 412 | 200 | 62 | 218 | 25 |
| time (s) | 172 | 82 | 465 | 270 | 117 | 298 | 32 |
| | 263 | 122 | 537 | 377 | 130 | 329 | 51 |
| | 299 | 153 | 605 | 442 | 369 | 366 | 55 |
| | 433 | 210 | 676 | 616 | 555 | 436 | 196 |
| Average | 221.5 | 106.5 | 504.8 | 322.3 | 169.5 | 302.8 | 40.8 |
| Standard | 70.7 | 38.3 | 84.2 | 108.0 | 136.2 | 63.0 | 14.5 |
| Deviation | | | | | | | |

Optimization of Antibody 3

TABLE 11
Optimization of the concentration of 5 deposited on the nitrocellulose.
Each dual channel device was challenged with 300 μL of 4.28
pg/mL CK in buffered water. The time difference was measured as
the concentration of 5 was varied. There were 6 replicates for
each concentration of 5. To account for errors in fabricating the
devices, the fastest and slowest assay times were not used in determining
the average or standard deviation values.

| | [5] (dilution factor) | | | | | |
|---|---|---|---|---|---|---|
| | 2000 | 1000 | 500 | 200 | 100 | 20 |
| Flow- | 3 | 98 | 33 | 284 | 195 | 37 |
| through | 12 | 417 | 160 | 412 | 328 | 228 |
| time (s) | 85 | 436 | 362 | 465 | 391 | 258 |
| | 193 | 475 | 601 | 537 | 436 | 268 |
| | 262 | 588 | 605 | 605 | 469 | 393 |
| | 346 | — | 668 | 676 | 577 | 1001 |
| Average | 2.3 | 8.0 | 7.2 | 8.4 | 6.8 | 4.8 |
| Standard | 1.9 | 1.3 | 3.6 | 1.4 | 1.0 | 1.2 |
| Deviation | | | | | | |

Calculation of Limits-of-Detection:

The limits-of-detection for all assays were defined as the 3× the standard deviation of the smallest value (within the linear region), divided by the slope of the linear region.

### DISCUSSION

The paper-based device, which imparts the quantitative time based readout to the assay, relies on the use of a hydrophobic detection reagent, compound 1 (FIG. 12). When 1 is deposited in the hydrophilic region of a paper-based device, it modulates the wetting properties of the paper, switching from hydrophilic to hydrophobic. This hydrophobic detection reagent will selectively undergo a conversion to hydrophilic products when exposed to hydrogen peroxide. This conversion occurs as a result of the oxidative cleavage of one the aryl boronate moieties on 1 that will then trigger an electron cascade, in the presence of a base (i.e., NaOH), switching the reagent from hydrophobic to its hydrophilic products. The rate at which 1 converts from hydrophobic to hydrophilic is dependent on the concentration of hydrogen peroxide within the sample.

The detection event of the assay (i.e., a sandwich based immunoassay) can be designed to generate hydrogen peroxide in situ with a concentration that is dependent on the initial concentration of the target analyte within the sample. This can be achieved using a three antibody system for the detection of the target analyte (FIG. 16). The first antibody, 3, is deposited on the nitrocellulose (as shown in FIG. 16), while the other two antibodies, 4 and 5, are deposited in the conjugate pad. Antibody 3 in this discussion is a monoclonal antibody for the target analyte, creatine kinase (CK), while antibody 4 is a polyclonal antibody for CK. Antibody 5 targets 4 and is labeled with glucose oxidase (GOX), which reacts with glucose to form hydrogen peroxide.

When no CK is present within the sample, 5 will bind to 4 and travel with the solvent front across the nitrocellulose, encountering glucose that has been deposited on the nitrocellulose. This will result in the formation of hydrogen peroxide, and then the subsequent rapid conversion of compound 1 from hydrophobic to hydrophilic. When the sample contains CK however, it will bind to both 3 and 4, which results in the GOX-labeled 5 being complexed and removed from solution prior to encountering glucose. As the concentration of CK increases, more 5 is removed from solution, and less hydrogen peroxide will be generated. With decreasing amounts of hydrogen peroxide generated (as a result of increasing concentrations of CK), the rate that 1 converts from hydrophobic to hydrophilic will decrease. After the sample has wicked past 1 it then encounters pre-deposited dye within the paper-device that causes the sample to become brightly colored. The now brightly colored solution reaches the top layer of the paper-based device, causing it to become colored. The time from the addition of the sample to the LFPIA device to the appearance of color on the top of the paper-based device corresponds to the initial concentration of CK present within the sample. As the concentration of CK increases, the time to appearance of color also increases.

What is claimed is:

1. An analytic apparatus, comprising:
a casing, comprising at least one sample addition port in fluid communication with at least one detection region via at least one flow layer, at least one assay channel, and at least one control channel, wherein:
said at least one flow layer comprises at least one hydrophilic region and at least one hydrophobic barrier; and,
said at least one hydrophilic region comprises at least one hydrophilic porous media configured to enable directional flow of fluids;
at least one hydrophobic detection reagent provided within at least one hydrophilic region, wherein said at least one hydrophobic detection reagent is configured to convert from hydrophobic to hydrophilic upon contact with at least one chemical promoter and/or modify wetting properties of said at least one hydrophilic region upon contact with at least one chemical promoter; and,
at least one responsive reagent provided within said at least one assay channel and/or said at least one control channel, wherein each at least one responsive reagent is configured, in response to presence and/or absence of at least one target analyte, to produce said at least one chemical promoter, not produce said at least one chemical promoter, or produce said at least one chemical promoter in amounts and/or at rates distinguishable within said at least one assay channel as compared to said at least one control channel;
wherein said fluid moves at differential rates due to said differential amounts and/or rates of said chemical promoter produced within said at least one assay channel and/or said at least one control channel; and,
wherein said apparatus is configured to determine a presence and/or concentration of said at least one target analyte within at least one sample when said at least one sample is introduced into said at least one a sample addition port.

2. The analytic apparatus recited in claim 1, wherein said at least one detection region is hydrophilic and said apparatus is configured to have said at least one assay channel and said at least one control channel directed towards said at least one detection region so that said sample, after being introduced into said at least one sample addition port, is split into at least a first sample-portion and a second sample-portion, wherein said sample-portions are differentially driven towards said at least one detection region.

3. The analytic apparatus recited in claim 2, wherein at least one detection signal is generated when said at least one sample-portion contacts said detection region.

4. The analytic apparatus recited in claim 1, wherein said casing comprises:
a lower portion and an upper portion, wherein each of said portion is configured to support internal structural components of said apparatus and facilitate operation thereof;
wherein said portions are configured to engage each other to encase said internal structural components and be held together via a fastening mechanism.

5. The analytic apparatus recited in claim 1, wherein a plurality of said hydrophilic, porous media and/or a plurality of said flow layers are held in contact with each other via a retention means to maintain physical contact between said plurality of hydrophilic, porous media and/or plurality of flow layers and to maintain alignment thereof.

6. The analytic apparatus recited in claim 3, wherein at least one coloring agent is provided within said at least one hydrophilic region of said at least one assay channel and/or said at least one control channel to provide said at least one detection signal.

7. The analytic apparatus recited in claim 3, wherein:
at least one electrolyte is provided within said at least one hydrophilic region of said at least one assay channel and/or said at least one control channel;
at least one electrical contact is provided within said at least one detection region; and,
said at least one electrical contact is configured to generate an electrical signal as said at least one detection signal.

8. The analytic apparatus recited in claim 7, wherein said at least one detection region and said at least one electrical contact are configured to be temporarily and/or permanently placed into electrical communication with an electronic detection device, wherein said electronic detection device is configured to quantify and/or illustrate said at least one detection signal received by said at least one detection region.

9. The analytic apparatus recited in claim 1, wherein said at least one assay channel and/or said at least one control channel is provided with an offset to skew travel distance and/or travel rate of said fluid moving through of said at least one assay channel and/or said at least one control channel.

10. The analytic apparatus recited in claim 9, wherein said offset is provided for by at least one of: (i) a distance-offset travelled to said at least one detection region; (ii) specific configuration said at least one hydrophobic barrier; (iii) setting material and physical properties of said at least one hydrophilic region; and/or (iv) configuring polymers to depolymerize at selected said at least one hydrophilic regions and/or said at least one hydrophobic barriers.

11. The analytic apparatus recited in claim 1, wherein:
at least one pad is placed into fluid communication with said at least one sample addition port and said at least one flow layer; and,
said at least one pad is provided with at least one de-contamination reagent.

12. The analytic apparatus recited in claim 1, wherein said at least one hydrophilic porous media is derivitized with at least one selectively binding responsive reagent to interact with said at least one target analyte.

13. The analytic apparatus recited in claim 1, further comprising additional reagents to: (i) detect analytes; (ii) modify a pH of said at least one sample; (iii) modify wetting properties said at least one hydrophilic, porous medium; (iv) generate supplementary reagents for selective use of said apparatus; and/or, (v) interact with other responsive reagents to initiate a signal transduction pathway.

14. The analytic apparatus recited in claim 3, wherein said at least one detection region is configured to generate said at least one detection signal that is detectable by an optical reader, wherein said optical reader comprises a light emitter and a photodetector configured to measure light reflected from said at least one detection region.

15. An analytic apparatus, comprising:
a casing, comprising at least one sample addition port in fluid communication with at least one detection region via at least one flow layer, at least one assay channel, and at least one control channel, wherein:
said at least one flow layer comprises at least one hydrophilic region and at least one hydrophobic barrier;
said at least one hydrophilic region comprises at least one hydrophilic porous media configured to enable directional flow of fluids via capillary action, wherein each hydrophilic region and said directional flow there-through is dictated by said at least one hydrophobic barrier; and,
said at least one hydrophobic barrier generates at least one of lateral directional flow and vertical directional flow;
at least one hydrophobic detection reagent provided within at least one hydrophilic region, wherein said at least one hydrophobic detection reagent is configured to convert from hydrophobic to hydrophilic upon contact with at least one chemical promoter and/or modify wetting properties of said at least one hydrophilic region upon contact with at least one chemical promoter;
at least one responsive reagent provided within said at least one assay channel and/or said at least one control channel, wherein each at least one responsive reagent is configured, in response to presence and/or absence of at least one target analyte, to produce said at least one chemical promoter, not produce said at least one chemical promoter, or produce said at least one chemical promoter in amounts and/or at rates distinguishable within said at least one assay channel as compared to said at least one control channel;
wherein said fluid wicks via capillary action at differential rates due to said differential amounts and/or rates of said chemical promoter produced within said at least one assay channel and/or said at least one control channel;
wherein said apparatus is configured to determine a presence and/or concentration of said at least one target analyte within at least one sample when said at least one sample is introduced into said at least one a sample addition port.

16. The analytic apparatus recited in claim 15, wherein said at least one detection region is hydrophilic and said apparatus is configured to have said at least one assay channel and said at least one control channel directed towards said at least one detection region so that said sample, after being introduced into said at least one sample addition port, is split into at least a first sample-portion and a second sample-portion, wherein said sample-portions are differentially driven towards said at least one detection region.

17. The analytic apparatus recited in claim 16, wherein at least one detection signal is generated when said at least one sample-portion contacts said detection region.

18. An analytic apparatus, comprising:
a casing, comprising at least one sample addition port in fluid communication with at least one detection region via at least one flow layer, at least one assay channel, and at least one control channel, wherein:
said at least one flow layer comprises at least one hydrophilic region and at least one hydrophobic barrier;
said at least one hydrophilic region comprises at least one hydrophilic porous media configured to enable directional flow of fluids, wherein:
each hydrophilic region and said directional flow there-through is dictated by said at least one hydrophobic barrier; and,
at least one hydrophilic region is configured to filter impurities of said fluids via selective pore size to sift said impurities and/or chemical binding of said impurities to said at least one hydrophilic porous media;
at least one hydrophobic detection reagent provided within at least one hydrophilic region, wherein said at least one hydrophobic detection reagent is configured to convert from hydrophobic to hydrophilic upon contact with at least one chemical promoter and/or modify wetting properties of said at least one hydrophilic region upon contact with at least one chemical promoter;
at least one responsive reagent provided within said at least one assay channel and/or said at least one control channel, wherein each at least one responsive reagent is configured, in response to presence and/or absence of at least one target analyte, to produce said at least one chemical promoter, not produce said at least one chemical promoter, or produce said at least one chemical promoter in amounts and/or at rates distinguishable within said at least one assay channel as compared to said at least one control channel;
wherein said fluid moves at differential rates due to said differential amounts and/or rates of said chemical promoter produced within said at least one assay channel and/or said at least one control channel; and,
wherein said at least one detection region is hydrophilic and said apparatus is configured so that said sample, after being introduced into said at least one sample addition port, is split into at least a first sample-portion and a second sample-portion.

19. The analytic apparatus recited in claim 18, wherein at least one detection signal is generated when said at least one sample-portion contacts said detection region.

20. The analytic apparatus recited in claim 19, wherein said at least one detection region is configured to generate said at least one detection signal that is detectable by an optical reader, wherein said optical reader comprises a light emitter and a photodetector configured to measure light reflected from said at least one detection region.

21. A compound of formula I: 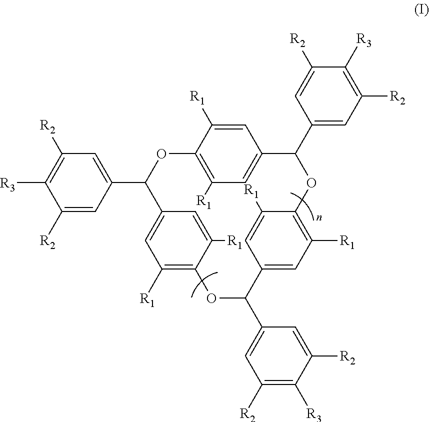
wherein:
R₁ is hydrogen or methyl;
R₂ is hydrogen or methyl;
R₃ is hydrogen, methoxy, oxypinacol boronic ester, or —OCH₂CHCH₂; and
n is 2, 3, 4, or 5.

22. A compound of formula (II): 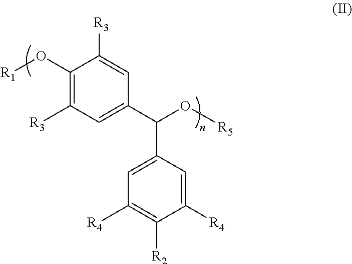
wherein:
R1 is hydrogen, acetyl, or pinacol boronic ester;
R2 is hydrogen, methoxy, oxypinacol boronic ester, or —OCH2CHCH2;
R3 is hydrogen or methyl;
R4 is hydrogen or methyl;
R5 is hydrogen, methyl, acetyl, —OH, or isopropyl; and
n is 2-1000.

23. A compound of formula (III) 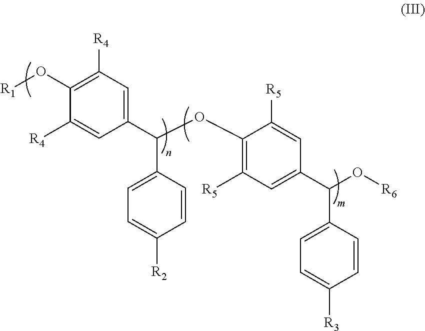
wherein: R1 is hydrogen, acetyl, or pinacol boronic ester;
R2 is hydrogen, methoxy, oxypinacol boronic ester, or —OCH2CHCH2;
R3 is hydrogen or methyl;
R4 is hydrogen or methyl;
R5 is hydrogen, methyl, isopropyl, or —OH;
n is 2-1000; and
m is 2-1000.
